(19) United States
(12) Patent Application Publication
(10) Pub. No.: US 2025/0175974 A1
(43) Pub. Date: May 29, 2025

(54) RESOURCE ALLOCATION IN A WIRELESS NETWORK

(71) Applicant: VIREWIRX, Inc., San Diego, CA (US)

(72) Inventors: Jaspreet Singh, San Diego, CA (US); David Edward Howard, San Diego, CA (US); Jose Armando Oviedo, San Diego, CA (US); Ali A. Elghariani, San Diego, CA (US); Siddhartha Mallik, San Diego, CA (US)

(21) Appl. No.: 18/960,543

(22) Filed: Nov. 26, 2024

Related U.S. Application Data
(60) Provisional application No. 63/603,034, filed on Nov. 27, 2023.

(51) Int. Cl. H04W 72/1263; H04B 17/309; H04W 28/22

(52) U.S. Cl. CPC H04W 72/1263; H04B 17/346; H04W 28/22

(57) ABSTRACT

Aspects of the disclosure relate to a multipoint environment in which an association approach is implemented that iteratively associates and/or re-associates STAs with APs to identify a combination of STA and AP pairs that results in the best collective set of channel conditions and/or in which a resource allocation approach is implemented that identifies the appropriate time slices for APs to serve associated STAs to minimize interference. The association and/or resource allocation approaches may be designed to take into account various network constraints. Thus, the resulting association and/or resource allocation may comply with the constraints of a network while also minimizing reliability and/or latency issues that persist with conventional techniques.

### CROSS-REFERENCE TO RELATED APPLICATIONS

This application claims the benefit of U.S. Provisional Application No. 63/603,034, entitled “RESOURCE ALLOCATION IN A WIRELESS NETWORK” and filed on Nov. 27, 2023, which is incorporated by reference herein in its entirety. Any and all applications for which a foreign or domestic priority claim is identified in the Application Data Sheet as filed with the present application, are hereby incorporated by reference under 37 CFR 1.57.

### BACKGROUND

### Technical Field

Embodiments of this disclosure relate to wireless communication systems, such as multiple-input multiple output wireless communication systems.

### Description of Related Technology

The types of modern computing devices continues to increase along with the differing and dynamic needs of each device. The wireless communication systems providing services to such devices are facing increasing constraints on resources and demands for quality and quantities of service. Accordingly, improvements in providing wireless communication services, such as in a multiple-input multiple-output system, are desired.

### SUMMARY

One aspect of the present disclosure provides an access point controller comprising a network interface. The access point controller further comprises a processor in communication with the network interface, wherein computer-executable instructions, when executed by the processor, cause the access point controller to: identify a plurality of slicing combinations for assigning a time slice in a schedule period to a station (STA) in a plurality of STAs in a multipoint environment; for each slicing combination in the plurality of slicing combinations, determine an achievable transmission data rate for each STA in the plurality of STAs if assigned to a time slice in accordance with the respective slicing combination; for each slicing combination in the plurality of slicing combinations, determine a minimum achievable transmission data rate of the determined achievable transmission data rates for the respective slicing combination; aggregate the minimum achievable transmission data rates; identify a first minimum achievable transmission data rate that is a maximum of the minimum achievable transmission data rates; and select a first slicing combination in the plurality of slicing combinations that corresponds with the first minimum achievable transmission data rate.

The access point controller of the preceding paragraph can include any sub-combination of the following features: where the computer-executable instructions, when executed, further cause the access point controller to partition a second plurality of STAs into the plurality of STAs and a third plurality of STAs, wherein the plurality of STAs is associated with the schedule period, and wherein the third plurality of STAs is associated with a second schedule period; where the computer-executable instructions, when executed, further cause the access point controller to: pair a first STA and a second STA in the second plurality of STAs to form a first STA pair based on a first level of interference associated with pairing the first STA and the second STA, pair a third STA and a fourth STA in the second plurality of STAs to form a second STA pair based on a second level of interference associated with pairing the third STA and the fourth STA, wherein the first STA pair and the second STA pair form a first set, pair the second STA and the third STA to form a third STA pair based on a third level of interference associated with pairing the second STA and the third STA, pair the fourth STA and the first STA to form a fourth STA pair based on a fourth level of interference associated with pairing the fourth STA and the first STA, wherein the third STA pair and the fourth STA pair form a second set, determine that a first transmission data rate associated with the first STA pair is lower than a second transmission data rate associated with the second STA pair, determine that a third transmission data rate associated with the third STA pair is lower than a fourth transmission data rate associated with the fourth STA pair, determine that the first transmission data rate is greater than the third transmission data rate, and form the plurality of STAs based on the first STA pair and the third plurality of STAs based on the second STA pair; where the computer-executable instructions, when executed, further cause the access point controller to associate each STA in the plurality of STAs with an access point in a plurality of access points; where the computer-executable instructions, when executed, further cause the access point controller to: determine a set of potential resident STAs in the plurality of STAs for each access point in the plurality of access points based on a metric, determine a set of viable primary access points in the plurality of access points for each STA in the plurality of STAs, assign an access point in the plurality of access points to each unassociated STA in the plurality of STAs, and update a current resident STA of each access point in the plurality of access points based on the metric and a maximum number of potential resident STAs that the respective access point can serve; where the computer-executable instructions, when executed, further cause the access point controller to assign a first unassociated STA in the plurality of STAs to a first access point in the plurality of access points that has a highest signal to noise ratio (SNR) with the first unassociated STA of the access points in the plurality of access points that are not serving a maximum number of STAs in the plurality of STAs; where the metric comprises a signal to noise ratio (SNR) measurement; where each unassociated STA in the plurality of STAs comprises a STA in the plurality of STAs that is not assigned to an access point in the plurality of access points; where the computer-executable instructions, when executed, further cause the access point controller to: identify a second minimum achievable transmission data rate that is the maximum of the minimum achievable transmission data rates, wherein the second minimum achievable transmission data rate corresponds with a second slicing combination in the plurality of slicing combinations, and select the first slicing combination in response to a determination that the first slicing combination has a tiebreaker over the second slicing combination; and where the tiebreaker is based on the first slicing combination having one of a higher sum of achievable transmission data rates for the plurality of STAs, a higher average achievable transmission data rate for the plurality of STAs, a higher median achievable transmission data rate for the plurality of STAs, or a higher maximum achievable transmission data rate for the plurality of STAs than the second slicing combination.

Another aspect of the disclosure provides a computer-implemented method comprising: identifying a plurality of slicing combinations for assigning a time slice in a schedule period to a station (STA) in a plurality of STAs in a multipoint environment; for each slicing combination in the plurality of slicing combinations, determining an achievable transmission data rate for each STA in the plurality of STAs if assigned to a time slice in accordance with the respective slicing combination; for each slicing combination in the plurality of slicing combinations, determining a minimum achievable transmission data rate of the determined achievable transmission data rates for the respective slicing combination; aggregating the minimum achievable transmission data rates; identifying a first minimum achievable transmission data rate that is a maximum of the minimum achievable transmission data rates; and selecting a first slicing combination in the plurality of slicing combinations that corresponds with the first minimum achievable transmission data rate.

The computer-implemented method of the preceding paragraph can include any sub-combination of the following features: where the computer-implemented method further comprises partitioning a second plurality of STAs into the plurality of STAs and a third plurality of STAs, wherein the plurality of STAs is associated with the schedule period, and wherein the third plurality of STAs is associated with a second schedule period; where partitioning a second plurality of STAs further comprises: pairing a first STA and a second STA in the second plurality of STAs to form a first STA pair based on a first level of interference associated with pairing the first STA and the second STA, pairing a third STA and a fourth STA in the second plurality of STAs to form a second STA pair based on a second level of interference associated with pairing the third STA and the fourth STA, wherein the first STA pair and the second STA pair form a first set, pairing the second STA and the third STA to form a third STA pair based on a third level of interference associated with pairing the second STA and the third STA, pairing the fourth STA and the first STA to form a fourth STA pair based on a fourth level of interference associated with pairing the fourth STA and the first STA, wherein the third STA pair and the fourth STA pair form a second set, determining that a first transmission data rate associated with the first STA pair is lower than a second transmission data rate associated with the second STA pair, determining that a third transmission data rate associated with the third STA pair is lower than a fourth transmission data rate associated with the fourth STA pair, determining that the first transmission data rate is greater than the third transmission data rate, and forming the plurality of STAs based on the first STA pair and the third plurality of STAs based on the second STA pair; where the computer-implemented method further comprises associating each STA in the plurality of STAs with an access point in a plurality of access points; where associating each STA in the plurality of STAs with an access point in a plurality of access points further comprises: determining a set of potential resident STAs in the plurality of STAs for each access point in the plurality of access points based on a metric, determining a set of viable primary access points in the plurality of access points for each STA in the plurality of STAs, assigning an access point in the plurality of access points to each unassociated STA in the plurality of STAs, and updating a current resident STA of each access point in the plurality of access points based on the metric and a maximum number of potential resident STAs that the respective access point can serve; where assigning an access point further comprises assigning a first unassociated STA in the plurality of STAs to a first access point in the plurality of access points that has a highest signal to noise ratio (SNR) with the first unassociated STA of the access points in the plurality of access points that are not serving a maximum number of STAs in the plurality of STAs; where the metric comprises a signal to noise ratio (SNR) measurement; where each unassociated STA in the plurality of STAs comprises a STA in the plurality of STAs that is not assigned to an access point in the plurality of access points; where selecting the first slicing combination further comprises: identifying a second minimum achievable transmission data rate that is the maximum of the minimum achievable transmission data rates, wherein the second minimum achievable transmission data rate corresponds with a second slicing combination in the plurality of slicing combinations, and selecting the first slicing combination in response to a determination that the first slicing combination has a tiebreaker over the second slicing combination; and where the tiebreaker is based on the first slicing combination having one of a higher sum of achievable transmission data rates for the plurality of STAs, a higher average achievable transmission data rate for the plurality of STAs, a higher median achievable transmission data rate for the plurality of STAs, or a higher maximum achievable transmission data rate for the plurality of STAs than the second slicing combination.

Another aspect of the disclosure provides a non-transitory, computer-readable storage medium comprising computer-executable instructions for assigning time slices to stations, wherein the computer-executable instructions, when executed by an access point controller, cause the access point controller to: identify a plurality of slicing combinations for assigning a time slice in a schedule period to a station (STA) in a plurality of STAs in a multipoint environment; for each slicing combination in the plurality of slicing combinations, determine an achievable transmission data rate for each STA in the plurality of STAs if assigned to a time slice in accordance with the respective slicing combination; for each slicing combination in the plurality of slicing combinations, determine a minimum achievable transmission data rate of the determined achievable transmission data rates for the respective slicing combination; aggregate the minimum achievable transmission data rates; identify a first minimum achievable transmission data rate that is a maximum of the minimum achievable transmission data rates; and select a first slicing combination in the plurality of slicing combinations that corresponds with the first minimum achievable transmission data rate.

The non-transitory, computer-readable storage medium of the preceding paragraph can include any sub-combination of the following features: where the computer-executable instructions, when executed, further cause the access point controller to partition a second plurality of STAs into the plurality of STAs and a third plurality of STAs, wherein the plurality of STAs is associated with the schedule period, and wherein the third plurality of STAs is associated with a second schedule period; where the computer-executable instructions, when executed, further cause the access point controller to: pair a first STA and a second STA in the second plurality of STAs to form a first STA pair based on a first level of interference associated with pairing the first STA and the second STA, pair a third STA and a fourth STA in the second plurality of STAs to form a second STA pair based on a second level of interference associated with pairing the third STA and the fourth STA, wherein the first STA pair and the second STA pair form a first set, pair the second STA and the third STA to form a third STA pair based on a third level of interference associated with pairing the second STA and the third STA, pair the fourth STA and the first STA to form a fourth STA pair based on a fourth level of interference associated with pairing the fourth STA and the first STA, wherein the third STA pair and the fourth STA pair form a second set, determine that a first transmission data rate associated with the first STA pair is lower than a second transmission data rate associated with the second STA pair, determine that a third transmission data rate associated with the third STA pair is lower than a fourth transmission data rate associated with the fourth STA pair, determine that the first transmission data rate is greater than the third transmission data rate, and form the plurality of STAs based on the first STA pair and the third plurality of STAs based on the second STA pair; where the computer-executable instructions, when executed, further cause the access point controller to associate each STA in the plurality of STAs with an access point in a plurality of access points; where the computer-executable instructions, when executed, further cause the access point controller to: determine a set of potential resident STAs in the plurality of STAs for each access point in the plurality of access points based on a metric, determine a set of viable primary access points in the plurality of access points for each STA in the plurality of STAs, assign an access point in the plurality of access points to each unassociated STA in the plurality of STAs, and update a current resident STA of each access point in the plurality of access points based on the metric and a maximum number of potential resident STAs that the respective access point can serve; where the computer-executable instructions, when executed, further cause the access point controller to assign a first unassociated STA in the plurality of STAs to a first access point in the plurality of access points that has a highest signal to noise ratio (SNR) with the first unassociated STA of the access points in the plurality of access points that are not serving a maximum number of STAs in the plurality of STAs; where the metric comprises a signal to noise ratio (SNR) measurement; where each unassociated STA in the plurality of STAs comprises a STA in the plurality of STAs that is not assigned to an access point in the plurality of access points; where the computer-executable instructions, when executed, further cause the access point controller to: identify a second minimum achievable transmission data rate that is the maximum of the minimum achievable transmission data rates, wherein the second minimum achievable transmission data rate corresponds with a second slicing combination in the plurality of slicing combinations, and select the first slicing combination in response to a determination that the first slicing combination has a tiebreaker over the second slicing combination; and where the tiebreaker is based on the first slicing combination having one of a higher sum of achievable transmission data rates for the plurality of STAs, a higher average achievable transmission data rate for the plurality of STAs, a higher median achievable transmission data rate for the plurality of STAs, or a higher maximum achievable transmission data rate for the plurality of STAs than the second slicing combination.

### BRIEF DESCRIPTION OF THE DRAWINGS

Embodiments of this disclosure will now be described, by way of non-limiting example, with reference to the accompanying drawings.

FIG. 1A is a diagram of a multipoint environment in which multiple stations and access points can communicate with each other according to an embodiment.

FIG. 1B is a schematic diagram illustrating a wireless network that includes the baseband unit according to an embodiment.

FIG. 2 is a flow diagram depicting a STA association routine 200 illustratively implemented by an AP controller, according to one embodiment.

FIG. 3 is a flow diagram depicting in greater detail a routine for assigning an AP to each unassociated STA, according to one embodiment.

FIG. 4 is a flow diagram depicting in greater detail a routine for updating the current resident STAs 110A-D of each of the APs, according to one embodiment.

FIG. 5 is a flow diagram depicting a resource allocation routine illustratively implemented by an AP controller, according to one embodiment.

FIGS. 6A-6B depict flow diagrams depicting in greater detail a routine for partitioning each AP-STA pair across one or more SPs, according to one embodiment.

FIGS. 7A-7B depict flow diagrams depicting in greater detail a routine for assigning time slices, according to one embodiment.

FIG. 8 is a flow diagram depicting an association and resource allocation routine illustratively implemented by an AP controller, according to one embodiment.

FIG. 9 is a block diagram illustrating an example baseband unit and remote radio unit according to an embodiment.

FIG. 10 is a schematic block diagram of an example STA according to an embodiment.

### DETAILED DESCRIPTION OF CERTAIN EMBODIMENTS

The following description of certain embodiments presents various descriptions of specific embodiments. However, the innovations described herein can be embodied in a multitude of different ways, for example, as defined and covered by the claims. In this description, reference is made to the drawings where like reference numerals can indicate identical or functionally similar elements. It will be understood that elements illustrated in the figures are not necessarily drawn to scale. Moreover, it will be understood that certain embodiments can include more elements than illustrated in a drawing and/or a subset of the elements illustrated in a drawing. Further, some embodiments can incorporate any suitable combination of features from two or more drawings. The headings provided herein are for convenience only and do not necessarily affect the scope or meaning of the claims.

As wireless networks are increasingly used to run services sensitive to reliability and/or latency issues (e.g., media streaming, video chat, virtual reality, augmented reality, etc.), any situations that negatively affect reliability and/or latency can be problematic. For example, a station (STA) may receive data packets from an access point (AP), where the data packets include a payload including content that the STA may display, present, or otherwise output. Reliability and/or latency issues can arise if a STA is assigned or associated with an AP where the channel conditions (e.g., signal to noise ratio (SNR)) between the STA and AP are poor. In some cases, it may be desirable to then assign or associate a STA with an AP where the channel between the STA and AP has the best conditions (e.g., the best SNR) among all channels between the STA and available APs. However, an AP may have a maximum number of STAs that the AP can serve, and often the AP associated with the best channel conditions may already be serving the maximum number of STAs and is therefore unavailable to serve a subject STA. The subject STA may then continue to experience reliability and/or latency issues.

In addition, other network constraints may prevent STAs from being assigned or associated with APs having the best channel conditions. For example, the channel conditions between a first STA and a first AP may be good generally. However, if a second STA is eventually assigned or associated with a second AP and is configured to send transmissions at the same time that the first STA and the first AP communicate, the transmissions between the second STA and the second AP could cause interference with the transmissions between the first STA and the first AP. Thus, not only may it be important to identify the appropriate AP with which to assign or associate a STA to reduce reliability and/or latency issues, it may also be important to identify the time slice in which a STA and AP pair should communicate.

Accordingly, described herein is an association approach that iteratively associates and/or re-associates STAs with APs to identify a combination of STA and AP pairs that results in the best collective set of channel conditions and/or a resource allocation approach that identifies the appropriate time slices for APs to serve associated STAs to minimize interference. The association and/or resource allocation approaches may be designed to take into account various network constraints. Thus, the resulting association and/or resource allocation may comply with the constraints of a network while also minimizing reliability and/or latency issues that persist with conventional techniques.

For example, a multipoint environment may be present in which multiple STAs and multiple APs are operating. At least some of the STAs may have already been associated with at least some of the APs by an AP controller. However, the association may not necessarily be an optimal association that minimizes AP and STA pairs with poor channel conditions. An AP controller in the multipoint environment may implement the association approach and/or the resource allocation approach described herein. In particular, the AP controller may be a component that provides data packets to one or more APs for eventual transmission to the STAs. The AP controller may determine which APs should serve which STAs and/or when each AP should serve a particular STA.

To implement the association approach, the AP controller can determine, for each AP in the multipoint environment, a set of potential resident STAs for the respective AP. A potential resident STA of an AP may be a STA for which the AP is a viable primary AP, but the AP is not currently the primary serving AP for the STA. A viable primary AP is an AP that is eligible to become a primary serving AP of a STA. For each AP, the AP controller can rank each potential resident STA for the respective AP using a metric. For example, the metric can be an SNR of a channel between the respective potential resident STA and the respective AP (where a potential resident STA with a higher SNR may be ranked higher), a signal to interference and noise ratio (SINR) of the channel between the respective potential resident STA and the respective AP (where a potential resident STA with a higher SINR may be ranked higher), a distance between the respective potential resident STA and the respective AP (where a potential resident STA with a longer distance to the respective AP may be ranked lower), a function of the SNR or a channel between the respective potential resident STA and the current serving AP of the respective potential resident STA and the SNR of a channel between the respective AP and the respective potential resident STA, a function of a distance between the respective potential resident STA and the current serving AP of the respective potential resident STA and a distance between the respective AP and the respective potential resident STA, and/or the like.

In addition, the AP controller can determine, for each STA in the multipoint environment, a set of viable primary APs for the respective STA. For example, if a STA is currently associated with a serving AP, an AP may be considered a viable primary AP for the STA if the SNR of a channel between the AP and the STA is greater than the SNR of the channel between the serving AP (e.g., an AP currently serving as the primary AP for a STA) and the STA, if the SNR of the channel between the AP and the STA is greater than that of the SNR of the channel between the serving AP and the STA beyond a threshold SNR (e.g., the SNR of the channel between the AP and the STA is greater than or equal to the SNR of the channel between the serving AP and the STA plus an acceptable SNR margin), and/or if the SNR of the channel between the AP and the STA is greater than the SNR of the channel between the serving AP and the STA beyond a threshold SNR for a threshold time duration (e.g., at least a threshold number of consecutive SNR measurement instances). In particular, if an SNR measurement is taken during each scheduling interval, then an AP may be considered a viable primary AP for a STA if the SNR measurement is greater than the SNR of the channel between the serving AP and the STA beyond a threshold SNR for at least a threshold number of scheduling intervals. As another example, if a STA is not currently associated with any serving AP (e.g., the STA is unassociated), an AP may be considered a viable primary AP for the STA if the SNR of a channel between the AP and the STA is greater than the SNR of all channels between the STA and all other APs or the SNR of the channel between the AP and the STA has a value that is within a threshold SNR of the SNR that is the greatest amongst all channels between the STA and all APs (e.g., the SNR plus an acceptable SNR margin is greater than or equal to the best SNR).

Once the AP controller identifies, for each AP, a set of potential resident STAs and, for each STA, a set of viable primary APs, the AP controller can assign unassociated STAs (if any are present) to a best available AP. For example, the AP controller can, for each unassociated STA, determine a highest SNR of the channels between the respective unassociated STA and each AP, identify a subset of APs that each have a channel with the respective unassociated STA that has an SNR within at least a threshold SNR of the best SNR and that are each serving less than a maximum number of STAs that the respective AP can handle, and assign the respective unassociated STA to an AP in the identified subset having a channel with the respective unassociated STA with the highest SNR. As described herein, a set of APs that each have a channel with the respective unassociated STA that has an SNR within at least a threshold SNR of the best SNR may be referred to herein as a set of initial viable primary APs. The identified subset of APs may be at least a subset of the set of initial viable primary APs. However, if each of the APs in the set of initial viable primary APs are serving a maximum number of STAs that the respective AP can handle, then the AP controller can assign the respective unassociated STA to an AP having a channel with the respective unassociated STA with the highest SNR.

Once the AP controller assigns each previously-unassociated STA to an AP, the AP controller can update the current resident STAs of some or all of the APs. For example, a current resident STA of an AP may be a STA that has the AP assigned as the primary serving AP of the STA. To update the current resident STAs of an AP, the AP controller can determine whether the AP is serving a maximum number of STAs that the AP can handle or whether the AP is serving less than the maximum number of STAs that the AP can handle.

If the AP is not serving the maximum number of STAs that the AP can handle, then the AP controller may rank each potential resident STA of the AP (e.g., rank each STA that could be served, but is not yet served, by the AP) by the metric (e.g., where a higher SNR may yield a higher rank, a higher SINR may yield a higher rank, a longer distance may yield a lower rank, etc.), and assign each potential resident STA to the AP in the ranked order until the number of STAs assigned to the AP reaches the maximum number of STAs that the AP can handle. The potential resident STAs that the AP controller assigns to the AP may have previously been assigned to one or more other APs (referred to herein as outgoing APs because these APs previously served one or more STAs and will not serve such STAs going forward). The AP controller can repeat the current resident STA update operations described herein for each of the outgoing APs given that the composition of the current resident STAs for each of the outgoing APs has changed.

If the AP is serving the maximum number of STAs that the AP can handle or once the update to the current resident STAs of an AP is complete in a situation in which the AP is not serving the maximum number of STAs that the AP can handle, then the AP controller may remove each current resident STA of the AP from being a potential resident STA of any dominated APs. As used herein, a dominated AP may be an AP that is a viable primary AP for a STA that is currently served by a second AP, and that has a channel with the STA that is associated with a metric that is lower than the metric associated with the channel between the STA and the second AP. In other words, a dominated AP may be an AP that could serve a STA, but the STA is currently being served by another AP that has better channel conditions with the STA. By removing each current resident STA of the AP from being a potential resident STA of any dominated APs, the AP controller has determined that each current resident STA of the AP that could be served by a second AP (e.g., a dominated AP) should not be reassigned to the second AP because the AP has better channel conditions with the current resident STAs than the second AP.

Generally, the AP controller can repeat the current resident STA update operations described above for each AP at least once. The AP controller may repeat the operations for a particular AP more than once if the AP happens to become an outgoing AP for a STA one or more times, where the operations can be repeated each time the AP becomes an outgoing AP. Otherwise, if the AP controller updates the current resident STAs of an AP and the AP does not later become an outgoing AP, then the AP controller may not repeat the operations with respect to this AP again (e.g., at least not until a new scheduling interval occurs). Once the AP controller has updated the current resident STAs for each AP and each outgoing AP subsequent to the AP becoming an outgoing AP, then the association may be complete.

While the present disclosure describes a particular approach that the AP controller may implement to perform association, this is not meant to be limiting. For example, the resource allocation approach discussed above can be implemented by the AP controller regardless of whether the AP controller implements the association approach described herein or another approach for associating STAs with APs.

To implement the resource allocation approach, the AP controller can partition AP and STA pairs (e.g., where an AP in a pair may be the primary serving AP for a STA in the pair) as uniformly as possible across one or more schedule periods (SPs) (e.g., assign each AP and STA pair as uniformly as possible to one or more SPs). Once the partition is complete, the AP controller can, within each SP, assign one or more time slices to each of the AP and STA pairs that are associated with, assigned, or partitioned to the respective SP.

To perform the partition, the AP controller can iteratively perform one or more grouping stages to form one or more groups of STAs (e.g., where a group of STAs may also be referred to herein as a group of AP and STA pairs given that each STA is associated with or assigned to a particular AP). In each grouping stage, the AP controller may take an input set of groups of STAs and generate an output set of groups of STAs in which the number of groups of STAs in the output set may be less than the number of groups of STAs in the input set. The AP controller may assign each STA in the multipoint environment to a group during each grouping stage, and therefore the size of each group of STAs may continue to grow as additional grouping stages are performed. The AP controller may continue to perform grouping stages until the output set of groups of STAs has a number of groups that equals the number of SPs. For example, assuming that there are N STAs (e.g., N STA and AP pairs) and K SPs, the AP controller can determine the number of grouping stages that may be performed to finalize the partition of the AP and STA pairs by identifying a minimum integer n that satisfies N≤K×2″ and setting the number of grouping stages to be performed to be equal to the value of n. As an illustrative example, if N is 8 and K is 2, then n may be 2 (e.g., the AP controller may perform two grouping stages to finalize the partition of the AP and STA pairs). As another illustrative example, if N is 37 and K is 5, then n may be 3 (e.g., the AP controller may perform three grouping stages to finalize the partition of the AP and STA pairs). As another illustrative example, if N is 15 and K is 3, then n may be 3 (e.g., the AP controller may perform three grouping stages to finalize the partition of the AP and STA pairs).

Within a grouping stage, the AP controller may start with an input set of groups of STAs. The input set of groups of STAs may either be a set of STAs that are each grouped into a separate group (e.g., if the grouping stage is the first grouping stage being performed) or the output set of groups of STAs output by the previously performed grouping stage. The AP controller may start with a first group of STAs in the input set and identify, for each remaining unpaired group of STAs in the input set, a level of interference that occurs when the respective remaining unpaired group of STAs in the input set is paired with the first group of STAs. The level of interference may be represented by a combined transmission data rate value that the AP controller can derive from the SNRs of channels between STAs and APs in each paired group. In particular, if a first group of STAs is paired with a second group of STAs, then it may be assumed that each STA in the first group may communicate with its respective associated AP and each STA in the second group may communicate with its respective associated AP during the same SP and/or time slice. The AP controller can measure or obtain an indication of the channel conditions (e.g., SNR) of the first group STA-AP channels and the second group STA-AP channels that would result if the STAs and/or APs in each group transmit data concurrently or overlapping in time. The AP controller can then determine the transmission data rate (e.g., an average transmission data rate, a lowest transmission data rate, a highest transmission data rate, etc.) for each first group STA-AP channel and each second group STA-AP channel using the measured or obtained SNR values. The AP controller may generate the combined transmission data rate based on each of the determined first group and second group transmission data rates (e.g., by averaging the first group and second group transmission data rates, by identifying a median transmission data rate in the first and second groups, etc.).

Once the AP controller has identified the level of interference between different pairs of the first group of STAs and a remaining unpaired group of STAs in the input set, the AP controller can identify a second group of STAs in the input set that results in a lowest level of interference (e.g., a highest combined transmission data rate) out of all of the remaining unpaired groups of STAs in the input set when paired with the first group of STAs in the input set. The AP controller can then pair the first group of STAs with this second group of STAs that results in the lowest level of interference. The AP controller can then, for the next remaining unpaired group of STAs in the input set, repeat the above operations to identify another remaining unpaired group of STAs in the input set that results in a lowest level of interference when paired with the next remaining unpaired group of STAs in the input set and pair these two remaining unpaired group of STAs. The AP controller can then repeat these operations until each group of STAs in the input set is paired with another group of STAs in the input set. The paired groups of STAs may collectively be referred to as a set of paired groups of STAs. The operations performed by the AP controller to form the set of paired groups of STAs (e.g., the operations that encompass starting with one group of STAs in the input set and identifying the level of interference when paired with other groups to forming the set of paired groups of STAs) may collectively be referred to herein as a group pairing process.

When the AP controller formed the set of paired groups of STAs, the AP controller started with a first group of STAs in the input set and then continued to remaining unpaired groups of STAs in the input set. Starting with the first group of STAs, however, may influence the pairs that are eventually formed to create the set of paired groups of STAs. For example, it may be that a first group of STAs in the input set results in a lowest level of interference if paired with a third group of STAs in the input set, and that a second group of STAs in the input set results in a lowest level of interference if paired with the third group of STAs in the input set. Because the AP controller started the group pairing process with the first group of STAs in the input set, the AP controller may pair the first and third groups of STAs. The AP controller may further pair the second group of STAs with another group of STAs that results in a level of interference that is low, but not as low as would occur if the second group of STAs was paired with the third group of STAs because the third group of STAs has already been paired with the first group of STAs. To account for this type of situation, the AP controller can repeat the group pairing process a number of times that equals the number of groups of STAs in the input set, where each group pairing process starts with a different group of STAs in the input set. For example, the first group pairing process may start with the first group of STAs in the input set, as explained above. The second group pairing process may start with the second group of STAs in the input set, the third group pairing process may start with the third group of STAs in the input set, and so on. As a result, the AP controller may form multiple sets of paired groups of STAs, where the number of sets of paired groups of STAs matches the number of groups of STAs in the input set.

The output set of groups of STAs produced by the AP controller at the conclusion of a grouping stage may be one of the sets of paired groups of STAs. To determine which of the sets of paired groups of STAs to select as the output set of groups of STAs, the AP controller can, for each set of paired groups of STAs, identify the transmission data rate associated with each STA in the respective set and the lowest transmission data rate of those identified transmission data rates. Thus, the AP controller may identify the lowest STA transmission data rate for each set of paired groups of STAs. The AP controller can then select as the output set of groups of STAs the set of paired groups of STAs that has the best (e.g., highest) lowest STA transmission data rate. If this grouping stage is the last grouping stage to be performed by the AP controller, then the output set of groups of STAs may be the final grouping or partition of STAs that are used when assigning time slices. For example, each STA group in the output set of groups of STAs may correspond with a different partition, and the STAs that fall within the same partition may be served in the same SP as described below.

To perform the time slice assignment, the AP controller may follow a set of network constraints. For example, the AP controller may assign each STA that corresponds with a particular partition to the same SP such that these STAs are served in the same SP. An SP may include one or more time slices. The smallest time slice in an SP may be referred to herein as a base slice. The AP controller may set the time duration of a base slice to be equal to a time duration of the SP divided by the number of STAs in a partition. The AP controller may assign each serving AP to at most a single assigned slice in an SP, where an assigned slice may be a contiguous time resource within an SP that can have a time duration that is a multiple of a time duration of a base slice. Generally, the time duration of a base slice may be sufficient for a single STA to be served, and therefore the time duration of an assigned slice may be at least N times the time duration of a base slice, where N is the number of STAs in the partition that a single AP serves. In other words, the minimum slice size or slice time duration that the AP controller may allocate to a serving AP may be a time duration of the base slice multiplied by the number of STAs in the partition that the serving AP serves. An assigned slice may have a time duration that is longer than the minimum slice size because the AP controller may assign multiple APs to the same assigned slice (where the time duration of the assigned slice would then be at least the sum of the minimum slice time duration of each assigned AP). In some embodiments, the AP controller may allocate longer time slices near the beginning of the SP. In other embodiments, the AP controller may allocate longer time slices near the end of the SP. In addition, if multiple STAs are served by the same AP, then the AP controller may assign those STAs to the same assigned slice.

Even with the network constraints, there may be multiple possible combinations of AP and/or STA time slice assignments within an SP. As an illustrative example, if 3 STAs are included in the same partition (e.g., STAs A, B, and C), then possible combinations of STA time slice assignments within the SP can include all 3 STAs being assigned to the same time slice (and therefore the SP would include one time slice), 3 different combinations of two STAs being assigned to the same time slice and the third STA being assigned to a separate time slice (e.g., A and B in a first time slice and C in a second time slice, A and C in a first time slice and B in a second time slice, and B and C in a first time slice and A in a second time slice, where the SP would then include 2 time slices), and all 3 STAs being assigned to a different time slice (and therefore the SP would include 3 time slices). The AP controller may therefore implement a slicing combination algorithm that can be used to maximize a minimum achieve transmission data rate.

For example, the AP controller can identify each possible slicing combination (e.g., each possible assignment of STAs in the partition to a time slice) that satisfies some or all of the network constraints identified herein. For each possible slicing combination, the AP controller can collect SINR and/or modulation and coding schemes (MCSs) with which each STA can be served for the respective slicing combination, determine an achievable transmission data rate of each STA (e.g., which may be based on the MCSs, SNR, SINR, etc.), and determine the lowest achievable transmission data rate of the determined achievable transmission data rates. Thus, the AP controller can identify the lowest achievable transmission data rate of each possible slicing combination. The AP controller can then determine the best (e.g., highest) lowest achievable transmission data rate of all the possible slicing combinations and select the slicing combination that resulted in the best lowest achievable transmission data rate. The AP controller may then assign STAs and/or APs to time slices in the SP in accordance with the selected slicing combination.

If multiple possible slicing combinations achieve the same best lowest achievable transmission data rate (e.g., two or more slicing combinations each have the highest lowest achievable transmission data rate), then the AP controller may implement a tiebreaker to select the best slicing combination from these multiple slicing combinations. For example, the AP controller may select the slicing combination that has the highest sum of STA transmission data rates, the highest average STA transmission data rate, the highest median STA transmission data rate, the best (e.g., highest) highest STA transmission data rate, and/or the like.

The AP controller can repeat the above operations for each SP such that some or all of the STAs in the multipoint environment are each assigned to a time slice in one of a plurality of SPs.

The AP controller, the APs, and the STAs described herein may operate in a multipoint environment. In an embodiment, the multipoint environment described herein is designed to operate at higher frequencies, such as at millimeter wave (mmW) frequencies, such as between 24 GHz to 300 GHz. In general, mmW frequencies can encompass at least some frequency ranges between 2 GHz to 3 GHz, at least some frequency ranges in the Super high frequency (SHF) bands (e.g., 3 GHz to 30 GHz), and/or at least some frequency ranges in the Extremely High Frequency (EHF) bands (e.g., 30 GHz to 300 GHz). The techniques described herein can be applied to networks operating at any suitable range of frequencies. In addition, the techniques described herein can be used for a variety of use cases, such as media streaming, video chat, virtual reality, augmented reality, etc.

### Multipoint Association and Diversity

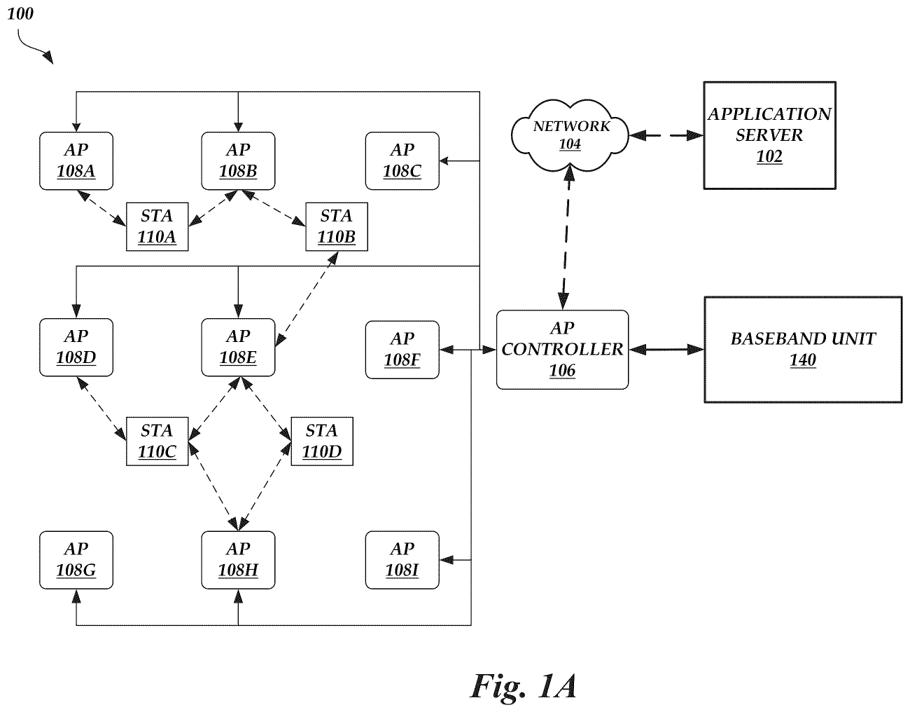

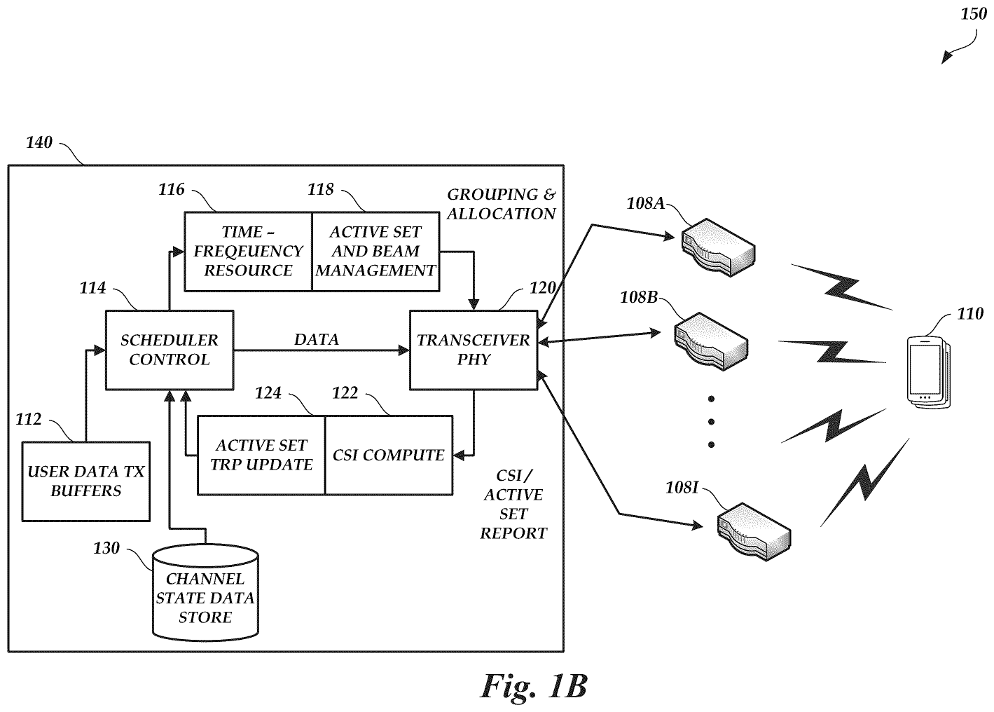

FIG. 1A is a diagram of a multipoint environment 100 in which multiple STAs 110A-D and APs 108A-I can communicate with each other according to an embodiment. As illustrated in FIG. 1A, the multipoint environment 100 includes a plurality of APs 108A-I, a plurality of STAs 110A-D, an AP controller 106, a baseband unit 140, and an application server 102 that optionally communicates with the AP controller 106 via a network 104. In an embodiment, data packets can be wirelessly transmitted from the baseband unit 140 to the plurality of STAs 110A-D via one or more of the APs 108A-I. In another embodiments, data packets can be transmitted from the application server 102 to the plurality of STAs 110A-D via one or more of the APs 108A-I via the network 104. Similarly, data packets can be transmitted from the plurality of STAs 110A-D to one or more APs 108A-I.

As described herein, a STA 110A-D can communicate with multiple APs 108A-I and an AP 108A-I can communicate with multiple STAs 110A-D in a single wireless stack (e.g., a single IEEE 920.11 protocol stack). For example, a STA 110A-D can authenticate simultaneously with multiple APs 108A-I (e.g., one or more of the APs 108A-I can individual or collectively authenticate the STA 110A-D upon request from the STA 110A-D) and decode any data packet that includes in a header or preamble a destination address that matches an address of the STA 110A-D, irrespective of the source address included in the header or preamble of the data packet (e.g., the STA 110A-D can decode any data packet that includes in a header or preamble a destination address that matches an address of the STA 110A-D whether or not the source address is the address of a particular AP 108A-I). Similarly, an AP 108A-I can decode any data packet that includes in a header or preamble a destination address that matches an address of the AP 108A-I or that matches a wildcard address associated with the AP 108A-I, irrespective of the source address included in the header of the data packet (e.g., the AP 108A-I can decode any data packet that includes in a header or preamble a destination address that matches an address of the AP 108A-I or that matches a wildcard address associated with the AP 108A-I whether or not the source address is the address of a particular STA 110A-D). For example, a wildcard address may be an address associated with multiple APs 108A-I rather than a unique address associated with just one AP 108A-I. As one illustrative example, the address associated with multiple APs 108A-I could be one or more addresses of one or more STAs 110A-D that has authenticated with some or all of the APs 108A-I. Thus, the wildcard address can be one or more addresses of one or more authenticated STAs 110A-D. As another example, an AP 108A-I can decode any data packet that includes in a header or preamble a source address that matches an address of one of a set of STAs 110A-D, such as an address of a STA 110A-D that has already authenticated with the AP 108A-I or another AP 108A-I that is part of the same wireless protocol stack as the AP 108A-I, irrespective of whether the destination address in the header or preamble matches an address of the AP 108A-I (e.g., the AP 108A-I can decode any data packet that includes in a header or preamble a source address that matches an address of one of a set of STAs 110A-D that has already authenticated with the AP 108A-I or another AP 108A-I that is part of the same wireless protocol stack whether or not the destination address is the address of the AP 108A-I itself).

For the purposes of illustration and not meant to be limiting, STA 110A communicates with APs 108A and 108B, STA 110B communicates with APs 108B and 108E, STA 110C communicates with APs 108D, 108E, and 108H, and STA 110D communicates with APs 108E and 108H. The STAs 110A-D and APs 108A-I, however, can communicate with other APs 108A-I and STAs 110A-D. Thus, unlike typical wireless network environments in which a basic service set (BSS) includes one AP assigned to one or more STAs, the multipoint environment 100 has no pre-defined AP 108A-I to which a STA 110A-D is associated. Rather, the AP 108A-I transmitting a data packet to a particular STA 110A-D can change on a packet-by-packet basis. For example, the AP 108D can transmit a first data packet to the STA 110C at a first time, the AP 108E can transmit a second data packet to the STA 110C at a second time, the AP 108H can transmit a third data packet to the STA 110C at a third time, the AP 108D can transmit a fourth data packet to the STA 110C at a fourth time, and so on. In fact, the AP 108A-I that transmits a data packet to the STA 110A-D can change without the STA 110A-D changing BSSs to which the STA 110A-D is associated—the STA 110A-D may remain in the same BSS using the same, single wireless stack while the AP 108A-I that transmits data packets to the STA 110A-D changes. Similarly, there may be no pre-defined STA 110A-D to which an AP 108A-I is associated. Rather, the STA 110A-D transmitting a data packet to a particular AP 108A-I can change on a packet-by-packet basis.

The AP controller 106 can be configured to select the AP 108A-I to transmit a data packet to a STA 110A-D. For example, the AP controller 106 can route traffic to one or more APs 108A-I for transmission to one or more STAs 110A-D based on downlink and/or uplink quality measurements. A downlink (DL) transmission generally refers to a communication from a network system (e.g., an AP) to a user terminal (e.g., a STA). An uplink (UL) transmission generally refers to a communication from the user terminal to the network system. The AP controller 106 may include one or more network interfaces to communicate via a wired and/or wireless connection (e.g., Ethernet, optical fiber, IEEE 902.11, etc.) with the baseband unit 140, the network 104, and/or the APs 108A-I. For example, the AP controller 106 may include one network interface that allows the AP controller 106 to communicate with each of the baseband unit 140, the network 104, and the APs 108A-I (where a switch coupled to the network interface or otherwise incorporated in the AP controller 106 may control to which component a transmission from the AP controller 106 is sent). As another example, the AP controller 106 may include a first network interface for communicating with the baseband unit 140, a second network interface for communicating with the network 104, and a third network interface for communicating with the APs 108A-I (where a switch coupled to the third network interface or otherwise incorporated in the AP controller 106 may control to which AP 108A-I a transmission from the AP controller 106 is sent). As another example, the AP controller 106 may include a first network interface for communicating with the baseband unit 140, a second network interface for communicating with the network 104, and one or more third network interfaces for communicating with the APs 108A-I (e.g., each AP 108A-I may receive communications from the AP controller 106 via a separate network interface, a first subset of the APs 108A-I may receive communications from the AP controller 106 via one network interface and a second subset of the APs 108A-I may receive communications from the AP controller 106 via another network interface, and/or any combination thereof). The AP controller 106 may also implement an association approach to find an optimal assignment or association of STAs with APs and/or a resource allocation approach to determine which pairs of STAs and APs can communicate during a same SP and when pairs of STAs and APs should communicate during an SP.

In the multipoint environment 100, the baseband unit 140 and the application server 102 are optional. The base station functionality may be subdivided between the baseband unit 140 and/or the application server 102, the AP controller 106, and/or multiple remote radio units (RRUs) (e.g., APs 108A-I). An RRU may include multiple antennas, and one or more of the antennas may serve as a transmit-receive point (TRP). The RRU and/or a TRP may be referred to as a serving node, a base station, or an access point. In an embodiment in which the baseband unit 140 is present, the baseband unit 140 may be physically connected to the AP controller 106 and/or the RRUs, such as via an optical fiber connection. The baseband unit 140 and/or the AP controller 106 may provide operational details to an RRU to control transmission and reception of signals from the RRU along with control data and payload data to transmit. The RRU may provide data to the network received from STAs 110A-D within a service area associated with the RRU. An RRU can provide service to devices (e.g., STAs 110A-D) within a service area. For example, wireless downlink transmission service may be provided by an RRU to the service area to communicate data to one or more devices within the service area.

The application server 102 may store or otherwise access content that can be streamed or downloaded to the STAs 110A-D via the network 104 and the AP controller 106. For example, the content can include audio, images, video, documents, and/or any other type of media. As an illustrative example, the application server 102 can be a server that provides content for an application running on a STA 110A-D, such as a media streaming application (e.g., a music streaming application, a television and/or movie streaming application, etc.), a video chat application, a virtual reality application, an augmented reality application, and/or the like. The application server 102 can transmit the content in one or more packets to the AP controller 106 via the network 104, where the transmission may occur over a wireless connection, over a wired connection, or over a combination of wired and wireless connections. The application server 102 and/or the AP controller 106 may provide operational details to an RRU to control transmission and reception of signals from the RRU along with control data and payload data (e.g., content) to transmit.

The APs 108A-I may each have one or more transmit antennas that each support one or more digital basebands. In some embodiments, each AP 108A-I has the same number of transmit antennas. In other embodiments, some or all APs 108a-I have a different number of transmit antennas than other APs 108A-I. Thus, the APs 108A-I may collectively be capable of transmitting N spatial beams, where N is the product of the number of APs 108A-I in the multipoint environment 100 and the number of transmit antennas operated by a single AP 108A-I. Similarly, each AP 108A-I can have the same number or different number of receive antennas. The baseband unit 140, the AP controller 106, and/or the APs 108A-I can be collectively referred to herein as a “network system.”

Various standards and protocols may be included in the multipoint environment 100 to wirelessly communicate data between a base station (e.g., an AP 108) and a wireless communication device (e.g., a STA 110). Some wireless devices may communicate using an orthogonal frequency-division multiplexing (OFDM) digital modulation scheme via a physical layer. OFDM standards and protocols can include the third generation partnership project (3GPP) long term evolution (LTE), the Institute of Electrical and Electronics Engineers (IEEE) 902.16 standard (e.g., 902.16e, 902.16m), which may be known as WiMAX (Worldwide interoperability for Microwave Access), and the IEEE 902.11 standard, which may be known as Wi-Fi. In some systems, a radio access network (RAN) may include one or more base stations associated with one or more evolved NodeBs (also commonly denoted as enhanced NodeBs, eNodeBs, or eNBs), next generation NodeBs (gNBs), or any other suitable NodeBs (xNBs). In other embodiments, radio network controllers (RNCs) may be provided as the base stations. A base station provides a bridge between the wireless network and a core network such as the Internet. The base station may be included to facilitate exchange of data for the wireless communication devices of the wireless network.

The wireless communication device may be referred to as a station (STA) (e.g., for wireless communication devices that communicate using the IEEE 902.11 standard). The wireless communication device may also be referred to as a user equipment (UE) (e.g., for wireless communication devices that communicate in a RAN) or a wireless terminal (WT) (e.g., for wireless communication devices that run a content-based application). The STA may be a device used by a user such as a smartphone, a laptop, a tablet computer, cellular telephone, a wearable computing device such as a headset or smart glasses or a smart watch or an ear piece, one or more networked appliances (e.g., consumer networked appliances or industrial plant equipment), an industrial robot with connectivity, or a vehicle. In some implementations, the STA may include a sensor or other networked device configured to collect data and wirelessly provide the data to a device (e.g., server) connected to a core network such as the Internet. Such devices may be referred to as Internet of Things devices (IoT devices).

The network 104 may include any wired network, wireless network, or combination thereof. For example, the network 104 may be a personal area network, local area network, wide area network, over-the-air broadcast network (e.g., for radio or television), cable network, satellite network, cellular telephone network, or combination thereof. As a further example, the network 104 may be a publicly accessible network of linked networks, possibly operated by various distinct parties, such as the Internet. In some embodiments, the network 104 may be a private or semi-private network, such as a corporate or university intranet. The network 104 may include one or more wireless networks, such as a Global System for Mobile Communications (GSM) network, a Code Division Multiple Access (CDMA) network, a Long Term Evolution (LTE) network, or any other type of wireless network. The network 104 can use protocols and components for communicating via the Internet or any of the other aforementioned types of networks. For example, the protocols used by the network 104 may include Hypertext Transfer Protocol (HTTP), HTTP Secure (HTTPS), Message Queue Telemetry Transport (MQTT), Constrained Application Protocol (CoAP), and the like. Protocols and components for communicating via the Internet or any of the other aforementioned types of communication networks are well known to those skilled in the art and, thus, are not described in more detail herein.

The AP controller 106 can function as a router to route traffic between the baseband unit 140 and/or the application server 102 and the APs 108A-I. The AP controller 106 can implement a relatively small amount of buffering. This can contribute to the AP controller 106 routing data between the baseband unit 140 and/or the application server 102 and the APs 108A-I with low latency. The AP controller 106 can include any suitable hardware to implement the functionality described herein.

The APs 108A-I can be arranged as an array. All of the APs 108A-I can be connected to the AP controller 106. The APs 108A-I can be connected to the AP controller 106 via wired or wireless connections. Each AP 108A-I can buffer a relatively low amount of frames of data at a time. For example, an AP 108A can buffer 1 or 2 frames of data at a time in certain applications. The frames can be relatively big frames. For example, one frame can include 100 to 150 Internet protocol (IP) packets. The APs 108A-I are arranged to wirelessly communicate with STAs 110A-D. The APs 108A-I can communicate via any suitable wireless links, such as wireless local area network (WLAN) links. WLAN signals can have a shorter signal range than cellular signals. In some instances, the WLAN signals can have a range of about 300 feet or less. WLAN signals can have a range of about 150 feet or less in certain applications. An example of a WLAN link is a Wi-Fi link. The WLAN link can be implemented based on an IEEE 902.11 standard. The APs 108A-I are networking hardware devices that include any suitable physical hardware to implement the functionalities disclosed herein. Although APs are described with reference to certain embodiments for illustrative purposes, any suitable principles and advantages described with references to access points can be implemented with any other suitable serving nodes of a network system. Any suitable wireless link that meets latency and throughput specifications can be used. Wi-Fi links, millimeter wave (mmW) wireless area network (WAN) links, and fifth generation (5G) New Radio (NR) links in Frequency Range 2 (FR2) are examples of such suitable wireless links.

FIG. 1B is a schematic diagram illustrating a wireless network 150 that includes the baseband unit 140 according to an embodiment. In this embodiment, the APs 108A-I may operate as RRUs or serving nodes, and the baseband unit 140 and/or the AP controller 106 (not shown) may select users (e.g., STAs 110, STA 110 receive antennas, etc.) to be served by one or more APs 108A-I over one or more time slots and/or over one or more spatial dimensions.

As illustrated in FIG. 1B, the baseband unit 140 includes user data TX buffers 112, the scheduler control 114, a time/frequency resource allocation block 116, an active set and beam management block 118, a transceiver 120, a CSI computation block 122, an active set serving node update block 124, and the channel state data store 130. The baseband unit 140 can include any suitable physical hardware to implement the illustrated blocks. For example, the baseband unit 140 can include a processor and computer readable storage to implement any suitable blocks shown in FIG. 1B. The wireless network 150 also includes the APs 108A-I, one or more STAs 110, and/or the AP controller 106 (not shown). The wireless network 150 optionally includes other APs 108, not shown.

The baseband unit 140 and/or the AP controller 106 includes a scheduler that selects users to serve over one or more spatial dimensions over one or more time slots, selects APs 108A-I to serve user data, and schedules user data for wireless transmission between the APs 108A-I and STAs 110 over various spatial dimensions (e.g., spatial beams, channels, etc.). The scheduler can schedule DL data traffic, UL data traffic, or both. The scheduler can schedule data from any suitable number of APs 108 to any suitable number of UEs 110. The scheduler can include the user data queue TX buffers 112, the scheduler control 114, the time/frequency resource allocation block 116, the active set and beam management block 118, the CSI computation block 122, the active set serving node update block 124, and/or the channel state data store 130.

The transceiver 120 can provide a STA report received from the STA 110 to the scheduler. For example, the STA report can include spatial beam link strengths, spatial beam link quality, and/or other CSI suitable for allowing the scheduler to schedule DL data transmissions and/or to schedule UL data transmissions. The CSI computation block 122 can compute CSI data from data in the STA report. The active set serving node update block 124 can determine an updated active set for one or more STAs 110 based on updated link strength information provided by the STA(s) 110 (e.g., provided by the STA(s) 110 in response to receiving DL data traffic). In some instances, the active set serving node update block 124 can determine an updated active set for a subset of one or more antennas of a STA 110. The active set serving node update block 124 can use any suitable metrics disclosed herein to update an active set associated with a STA 110.

The transceiver 120 can also provide a beam visibility report received from the STA 110 and/or AP 108 to the scheduler. The beam visibility report can indicate which AP 108 has started transmitting UL data to a STA 110 in response to a blockage, obstruction, or other interference. For example, one AP 108 may have initially been serving a STA 110. Due to an obstruction or interference, however, another AP 108 may start serving the STA 110 instead. The beam visibility report can inform the scheduler of the new AP 108 that has started serving the STA 110 instead. The scheduler (e.g., the active set serving node update block 124) can use this information to determine an updated active set for the STA 110 (e.g., update information identifying the beam(s) serving the STA 110, which may now include the beam from the new AP 108 serving the STA 110, such that future DL transmissions to the STA 110 are completed using at least one of the identified beam(s)).

Alternatively or in addition, the beam visibility report can include information from a STA 110 indicating that the STA 110 cannot receive transmissions from a beam transmitted by an AP 108 originally assigned to serve the STA 110, but that the STA 110 can receive transmissions from a beam transmitted by another AP 108. The scheduler (e.g., the active set serving node update block 124) can use this information to determine an updated active set for the STA 110 (e.g., update information identifying the beam(s) serving the STA 110, which may now include the beam from the another AP 108 that the STA 110 can see, such that future DL transmissions to the STA 110 are completed using at least one of the identified beam(s)).

The updated active set data is provided to the scheduler control 114. The user data queue TX buffers 112 can provide user data (e.g., DL user data) to the scheduler control 114. The scheduler control 114 provides user data to the transceiver 120 and also provides instructions to the time/frequency resource allocation block 116. The time/frequency resource allocation block 116 can schedule timing and frequency of DL and/or UL data transmission from and/or to APs 108 (e.g., generate scheduling data), which can be forwarded to the APs 108 via the transceiver 120 and/or the AP controller 106. This can avoid timing conflicts and conflicts in the frequency domain. The active set and beam management block 118 can select APs 108 and/or specific spatial beams offered by these APs 108 for providing wireless transmission services to STAs 110, and create corresponding active sets for the STAs 110. The active set and beam management block 118 can group DL data transmissions and manage beamforming from the APs 108 to the STAs 110. The transceiver 120 provides data for transmission by the APs 108 to STAs 110.

As illustrated in FIG. 1B, the scheduler can cause a network system of the wireless network 150 to wirelessly transmit first user data to a first STA 110 across one or more spatial beams or spatial dimensions, to transmit second user data to a second STA 110 across one or more spatial beams or spatial dimensions, and so on. The scheduler can cause the transmissions of the first user data, the second user data, etc. to occur simultaneously and/or at different times. Moreover, the scheduler can cause a network system of the wireless network 150 to wirelessly transmit user data to any suitable number of STAs 110 across one or more spatial beams or spatial dimensions served by one or more APs 108.

### Association Routines

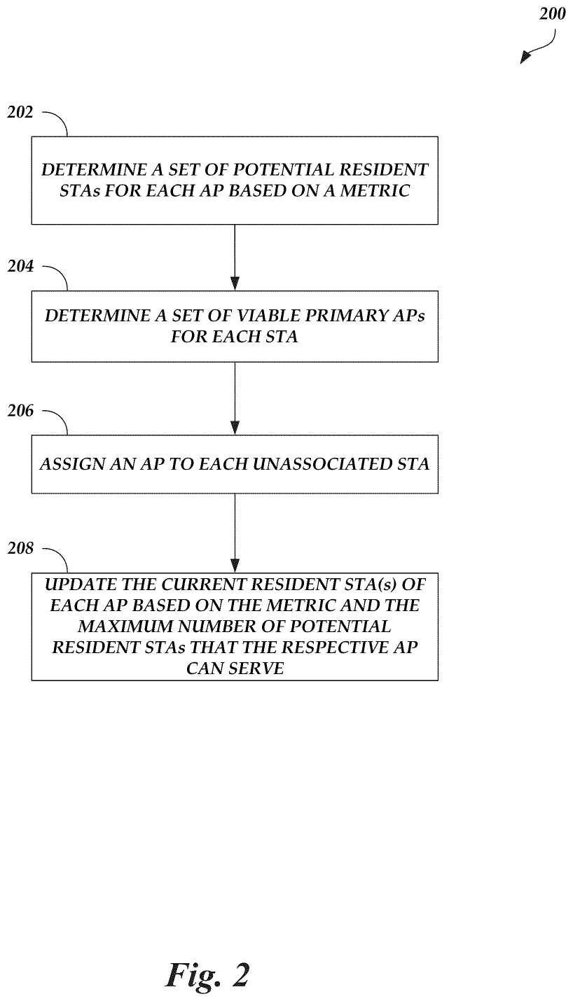

FIG. 2 is a flow diagram depicting a STA association routine 200 illustratively implemented by an AP controller, according to one embodiment. As an example, the AP controller 106 can be configured to execute the STA association routine 200. The STA association routine 200 begins at block 202.

At block 202, a set of potential resident STAs 110A-D for each AP 108A-I is determined based on a metric. For example, a potential resident STA 110A-D of an AP 108A-I may be a STA 110A-D for which the AP 108A-I is a viable primary AP, but the AP 108A-I is not currently the primary serving AP for the STA 110A-D. A viable primary AP is an AP 108A-I that is eligible to become a primary serving AP of a STA 110A-D. For each AP 108A-I, the AP controller 106 can rank each potential resident STA 110A-D for the respective AP 108A-I using a metric. For example, the metric can be an SNR of a channel between the respective potential resident STA 110A-D and the respective AP 108A-I (where a potential resident STA 110A-D with a higher SNR may be ranked higher), a signal to interference and noise ratio (SINR) of the channel between the respective potential resident STA 110A-D and the respective AP 108A-I (where a potential resident STA 110A-D with a higher SINR may be ranked higher), a distance between the respective potential resident STA 110A-D and the respective AP 108A-I (where a potential resident STA 110A-D with a longer distance to the respective AP 108A-I may be ranked lower), a function of the SNR or a channel between the respective potential resident STA 110A-D and the current serving AP 108A-I of the respective potential resident STA 110A-D and the SNR of a channel between the respective AP 108A-I and the respective potential resident STA 110A-D, a function of a distance between the respective potential resident STA 110A-D and the current serving AP 108A-I of the respective potential resident STA 110A-D and a distance between the respective AP 108A-I and the respective potential resident STA 110A-D, and/or the like.

At block 204, a set of viable primary APs 108A-I for each STA 110A-D is determined. For example, if a STA 110A-D is currently associated with a serving AP 108A-I, an AP 108A-I may be considered a viable primary AP for the STA 110A-D if the SNR of a channel between the AP 108A-I and the STA 110A-D is greater than the SNR of the channel between the serving AP 108A-I (e.g., an AP 108A-I currently serving as the primary AP for a STA 110A-D) and the STA 110A-D, if the SNR of the channel between the AP 108A-I and the STA 110A-D is greater than that of the SNR of the channel between the serving AP 108A-I and the STA 110A-D beyond a threshold SNR (e.g., the SNR of the channel between the AP 108A-I and the STA 110A-D is greater than or equal to the SNR of the channel between the serving AP 108A-I and the STA 110A-D plus an acceptable SNR margin), and/or if the SNR of the channel between the AP 108A-I and the STA 110A-D is greater than the SNR of the channel between the serving AP 108A-I and the STA 110A-D beyond a threshold SNR for a threshold time duration (e.g., at least a threshold number of consecutive SNR measurement instances). In particular, if an SNR measurement is taken during each scheduling interval, then an AP 108A-I may be considered a viable primary AP 108A-I for a STA 110A-D if the SNR measurement is greater than the SNR of the channel between the serving AP 108A-I and the STA 110A-D beyond a threshold SNR for at least a threshold number of scheduling intervals. As another example, if a STA 110A-D is not currently associated with any serving AP 108A-I (e.g., the STA 110A-D is unassociated), an AP 108A-I may be considered a viable primary AP for the STA 110A-D if the SNR of a channel between the AP 108A-I and the STA 110A-D is greater than the SNR of all channels between the STA 110A-D and all other APs 108A-I or the SNR of the channel between the AP 108A-I and the STA 110A-D has a value that is within a threshold SNR of the SNR that is the greatest amongst all channels between the STA 110A-D and all APs 108A-I (e.g., the SNR plus an acceptable SNR margin is greater than or equal to the best SNR).

At block 206, an AP 108A-I is assigned to each unassociated STA 110A-D. For example, the AP controller 106 can, for each unassociated STA 110A-D, determine a highest SNR of the channels between the respective unassociated STA 110A-D and each AP 108A-I, identify a subset of APs 108A-I that each have a channel with the respective unassociated STA 110A-D that has an SNR within at least a threshold SNR of the best SNR and that are each serving less than a maximum number of STAs 110A-D that the respective AP 108A-I can handle, and assign the respective unassociated STA 110A-D to an AP 108A-I in the identified subset having a channel with the respective unassociated STA 110A-D with the highest SNR. As described herein, a set of APs 108A-I that each have a channel with the respective unassociated STA 110A-D that has an SNR within at least a threshold SNR of the best SNR may be referred to herein as a set of initial viable primary APs. The identified subset of APs 108A-I may be at least a subset of the set of initial viable primary APs 108A-I. However, if each of the APs 108A-I in the set of initial viable primary APs 108A-I are serving a maximum number of STAs that the respective AP 108A-I can handle, then the AP controller 106 can assign the respective unassociated STA 110A-D to an AP 108A-I having a channel with the respective unassociated STA 110A-D with the highest SNR.

At block 208, the current resident STAs 110A-D of each AP 108A-I are updated based on the metric and the maximum number of potential resident STAs that the respective AP 108A-I can serve. For example, a current resident STA 110A-D of an AP 108A-I may be a STA 110A-D that has the AP 108A-I assigned as the primary serving AP of the STA 110A-D. To update the current resident STAs 110A-D of an AP 108A-I, the AP controller 106 can determine whether the AP 108A-I is serving a maximum number of STAs 110A-D that the AP 108A-I can handle or whether the AP 108A-I is serving less than the maximum number of STAs 110A-D that the AP 108A-I can handle. If the AP 108A-I is serving the maximum number of STAs 110A-D that the AP 108A-I can handle, then the AP controller 106 may remove each current resident STA 110A-D of the AP 108A-I from being a potential resident STA 110A-D of any dominated APs. As used herein, a dominated AP may be an AP 108A-I that is a viable primary AP for a STA 110A-D that is currently served by a second AP 108A-I, and that has a channel with the STA 110A-D that is associated with a metric that is lower than the metric associated with the channel between the STA 110A-D and the second AP 108A-I. In other words, a dominated AP may be an AP 108A-I that could serve a STA 110A-D, but the STA 110A-D is currently being served by another AP 108A-I that has better channel conditions with the STA 110A-D. By removing each current resident STA 110A-D of the AP 108A-I from being a potential resident STA 110A-D of any dominated APs, the AP controller 106 has determined that each current resident STA 110A-D of the AP 108A-I that could be served by a second AP 108A-I (e.g., a dominated AP) should not be reassigned to the second AP 108A-I because the AP 108A-I has better channel conditions with the current resident STAs 110A-D than the second AP 108A-I.

If the AP 108A-I is not serving the maximum number of STAs 110A-D that the AP 108A-I can handle, then the AP controller 106 may rank each potential resident STA 110A-D of the AP 108A-I (e.g., rank each STA 110A-D that could be served, but is not yet served, by the AP 108A-I) by the metric (e.g., where a higher SNR may yield a higher rank, a higher SINR may yield a higher rank, a longer distance may yield a lower rank, etc.), and assign each potential resident STA 110A-D to the AP 108A-I in the ranked order until the number of STAs 110A-D assigned to the AP 108A-I reaches the maximum number of STAs 110A-D that the AP 108A-I can handle. The potential resident STAs 110A-D that the AP controller 106 assigns to the AP 108A-I may have previously been assigned to one or more other APs 108A-I (referred to herein as outgoing APs because these APs 108A-I previously served one or more STAs 110A-D and will not serve such STAs 110A-D going forward). The AP controller 106 can repeat the current resident STA update operations described herein for each of the outgoing APs 108A-I given that the composition of the current resident STAs 110A-D for each of the outgoing APs 108A-I has changed.

If the AP 108A-I is serving the maximum number of STAs 110A-D that the AP 108A-I can handle or once the update to the current resident STAs 110A-D of an AP 108A-I is complete in a situation in which the AP 108A-I is not serving the maximum number of STAs 110A-D that the AP 108A-I can handle, then the AP controller 106 may remove each current resident STA 110A-D of the AP 108A-I from being a potential resident STA 110A-D of any dominated APs. As used herein, a dominated AP may be an AP 108A-I that is a viable primary AP for a STA 110A-D that is currently served by a second AP 108A-I, and that has a channel with the STA 110A-D that is associated with a metric that is lower than the metric associated with the channel between the STA 110A-D and the second AP 108A-I. In other words, a dominated AP may be an AP 108A-I that could serve a STA 110A-D, but the STA 110A-D is currently being served by another AP 108A-I that has better channel conditions with the STA 110A-D. By removing each current resident STA 110A-D of the AP 108A-I from being a potential resident STA 110A-D of any dominated APs, the AP controller 106 has determined that each current resident STA 110A-D of the AP 108A-I that could be served by a second AP 108A-I (e.g., a dominated AP) should not be reassigned to the second AP 108A-I because the AP 108A-I has better channel conditions with the current resident STAs 110A-D than the second AP 108A-I.

Generally, the AP controller 106 can repeat the current resident STA update operations described above for each AP 108A-I at least once. The AP controller 106 may repeat the operations for a particular AP 108A-I more than once if the AP 108A-I happens to become an outgoing AP for a STA 110A-D one or more times, where the operations can be repeated each time the AP 108A-I becomes an outgoing AP. Otherwise, if the AP controller 106 updates the current resident STAs 110A-D of an AP 108A-I and the AP 108A-I does not later become an outgoing AP, then the AP controller 106 may not repeat the operations with respect to this AP 108A-I again (e.g., at least not until a new scheduling interval occurs). Once the AP controller 106 has updated the current resident STAs 110A-D for each AP 108A-I and each outgoing AP subsequent to the AP 108A-I becoming an outgoing AP, then the association may be complete.

After the current resident STA(s) are updated, the STA association routine 200 ends.

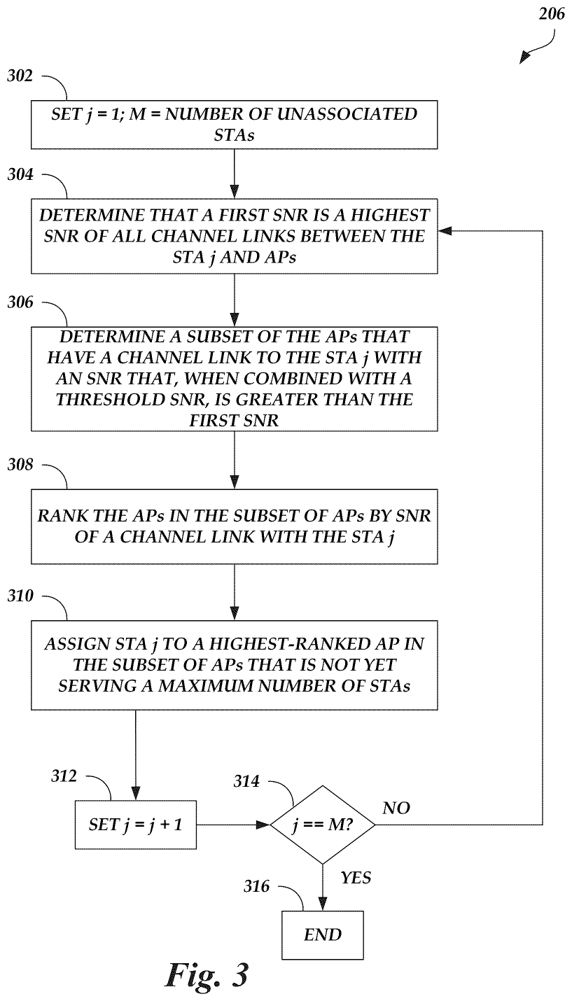

FIG. 3 is a flow diagram depicting in greater detail a routine for assigning an AP 108A-I to each unassociated STA 110A-D, according to one embodiment. As an example, the AP controller 106 can be configured to execute the routine, which may represent the operations performed in block 206 of FIG. 2. The routine of block 206 begins at block 302.

At block 302, a variable j is set to 1 and a variable M is set to be equal to the number of unassociated STAs 110A-D. The variable j may identify a particular unassociated STA 110A-D.

At block 304, a determination is made that a first SNR is a highest SNR of all channel links between the STA j and the APs 108A-I. The first SNR may be considered the best SNR of all channel links.

At block 306, a subset of the APs 108A-I that have a channel link to the STA j with an SNR that, when combined with a threshold SNR (or SNR margin value), is greater than the first SNR is determined.

At block 308, the APs 108A-I in the subset are ranked by SNR of a channel link with the STA j.

At block 310, STA j is assigned to a highest-ranked AP 108A-I in the subset of APs 108A-I that is not yet serving a maximum number of STAs 110A-D.

At block 312, the variable j is incremented by one to move to the next unassociated STA 110A-D.

At block 314, a determination is made as to whether j is equal to M. If j is equal to M, the routine of block 206 proceeds to block 316 and the routine ends. Otherwise, if j is not equal to M, the routine of block 206 reverts back to block 304 and blocks 304, 306, 308, and 310 are repeated for the next unassociated STA 110A-D.

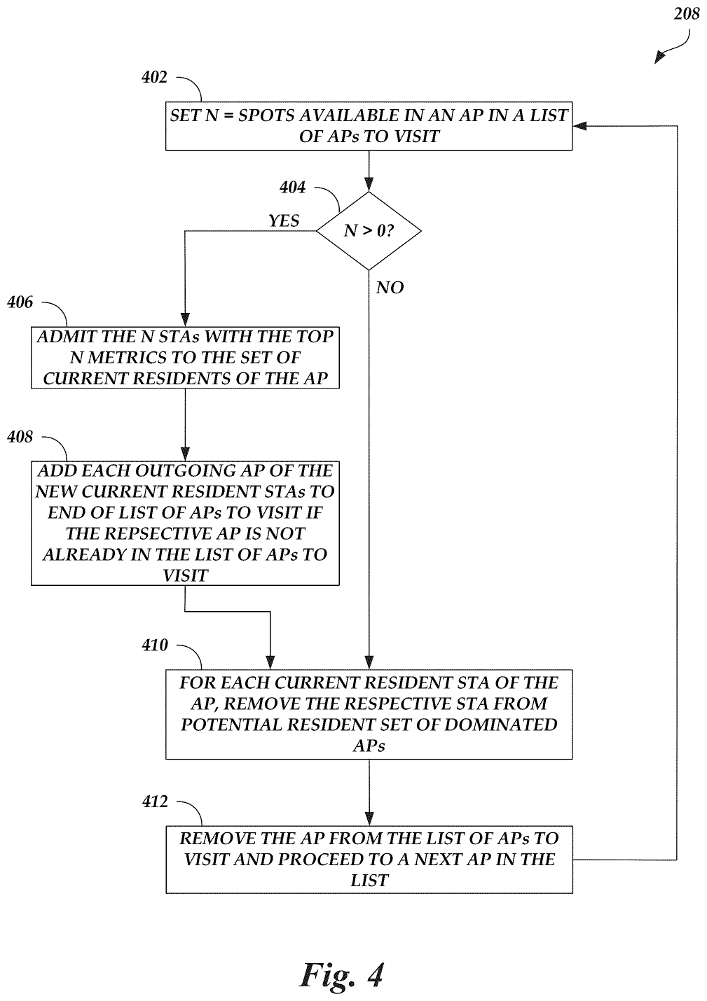

FIG. 4 is a flow diagram depicting in greater detail a routine for updating the current resident STAs 110A-D of each of the APs 108A-I, according to one embodiment. As an example, the AP controller 106 can be configured to execute the routine, which may represent the operations performed in block 208 of FIG. 2. The routine of block 208 begins at block 402.

At block 402, a variable N is set to be equal to the spots available in an AP 108A-I in a list of APs 108A-I to visit. Initially, the list of APs 108A-I to visit may include all of the APs 108A-I.

At block 404, a determination is made as to whether N is greater than 0. If N is greater than 0, then the routine of block 208 proceeds to block 406. Otherwise, if N is not greater than 0, then the routine of block 208 proceeds to block 410.

At block 406, the N STAs (e.g., the N potential resident STAs 110A-D) with the top N metrics are admitted to the set of current residents of the AP 108A-I. In some cases, less than N STAs may be admitted if the number of potential resident STAs 110A-D for the AP 108A-I is less than N.

At block 408, each outgoing AP 108A-I of the new current resident STAs 110A-D is added to an end of the list of APs 108A-I to visit if the respective outgoing AP is not already in the list of APs 108A-I to visit.

At block 410, for each current resident STA 110A-D of the AP 108A-I, the respective current resident STA 110A-D is removed from the set of potential resident STAs 110A-D of any dominated APs. In other words, the current resident STAs 110A-D of the AP 108A-I may not be reassigned to another AP 108A-I if the current AP 108A-I is the best serving AP.

At block 412, the AP 108A-I is removed from the list of APs 108A-I to visit and the routine of block 208 then reverts back to block 402 to repeat blocks 402, 404, 406, 408, 410, and/or 412 for the next AP 108A-I in the list. The routine of block 208 may end when the list of APs 108A-I to visit is empty.

### Resource Allocation Routines

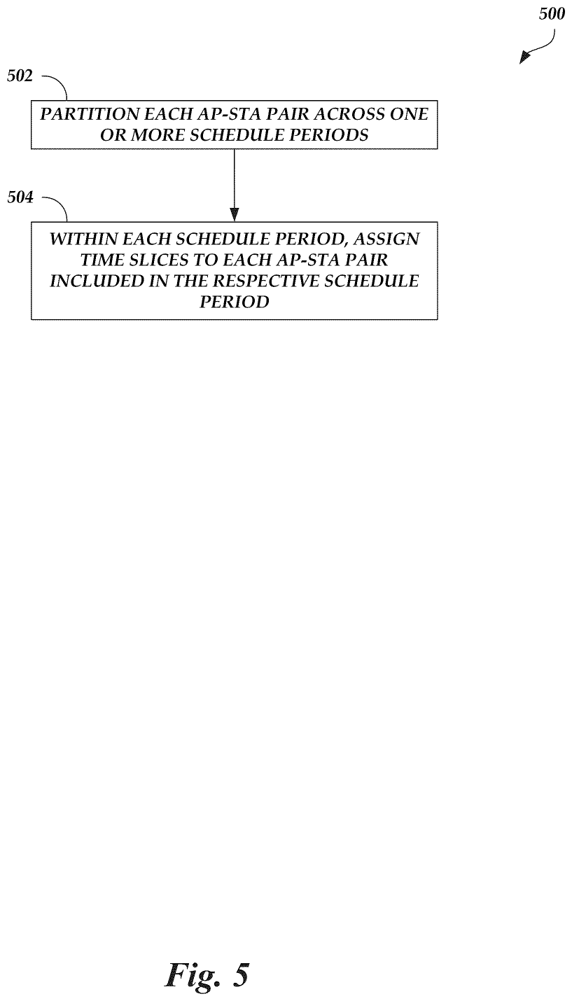

FIG. 5 is a flow diagram depicting a resource allocation routine 500 illustratively implemented by an AP controller, according to one embodiment. As an example, the AP controller 106 can be configured to execute the resource allocation routine 500. The resource allocation routine 500 begins at block 502.

At block 502, each AP-STA pair is partitioned across one or more schedule periods. In other words, each AP-STA pair is assigned to a schedule period. For example, the AP controller can partition AP 108A-I and STA 110A-D pairs (e.g., where an AP 108A-I in a pair may be the primary serving AP for a STA 110A-D in the pair as determined by an association approach) as uniformly as possible across one or more schedule periods (SPs). To perform the partition, the AP controller 106 can iteratively perform one or more grouping stages to form one or more groups of STAs 110A-D (e.g., where a group of STAs 110A-D may also be referred to herein as a group of AP 108A-I and STA 110A-D pairs given that each STA 110A-D is associated with or assigned to a particular AP 108A-I). In each grouping stage, the AP controller 106 may take an input set of groups of STAs 110A-D and generate an output set of groups of STAs 110A-D in which the number of groups of STAs 110A-D in the output set may be less than the number of groups of STAs 110A-D in the input set. The AP controller 106 may assign each STA 110A-D in the multipoint environment to a group during each grouping stage, and therefore the size of each group of STAs 110A-D may continue to grow as additional grouping stages are performed. The AP controller 106 may continue to perform grouping stages until the output set of groups of STAs 110A-D has a number of groups that equals the number of SPs. For example, assuming that there are N STAs (e.g., N STA and AP pairs) and K SPs, the AP controller 106 can determine the number of grouping stages that may be performed to finalize the partition of the AP 108A-I and STA 110A-D pairs by identifying a minimum integer n that satisfies N≤K×2″ and setting the number of grouping stages to be performed to be equal to the value of n. As an illustrative example, if N is 8 and K is 2, then n may be 2 (e.g., the AP controller 106 may perform two grouping stages to finalize the partition of the AP 108A-I and STA 110A-D pairs). As another illustrative example, if N is 37 and K is 5, then n may be 3 (e.g., the AP controller 106 may perform three grouping stages to finalize the partition of the AP 108A-I and STA 110A-D pairs). As another illustrative example, if N is 15 and K is 3, then n may be 3 (e.g., the AP controller 106 may perform three grouping stages to finalize the partition of the AP 108A-I and STA 110A-D pairs).

Within a grouping stage, the AP controller 106 may start with an input set of groups of STAs 110A-D. The input set of groups of STAs 110A-D may either be a set of STAs 110A-D that are each grouped into a separate group (e.g., if the grouping stage is the first grouping stage being performed) or the output set of groups of STAs 110A-D output by the previously performed grouping stage. The AP controller 106 may start with a first group of STAs 110A-D in the input set and identify, for each remaining unpaired group of STAs 110A-D in the input set, a level of interference that occurs when the respective remaining unpaired group of STAs 110A-D in the input set is paired with the first group of STAs 110A-D. The level of interference may be represented by a combined transmission data rate value that the AP controller 106 can derive from the SNRs of channels between STAs 110A-D and APs 108A-I in each paired group. In particular, if a first group of STAs 110A-D is paired with a second group of STAs 110A-D, then it may be assumed that each STA 110A-D in the first group may communicate with its respective associated AP 108A-I and each STA 110A-D in the second group may communicate with its respective associated AP 108A-I during the same SP and/or time slice. The AP controller 106 can measure or obtain an indication of the channel conditions (e.g., SNR) of the first group STA-AP channels and the second group STA-AP channels that would result if the STAs 110A-D and/or APs 108A-I in each group transmit data concurrently or overlapping in time. The AP controller 106 can then determine the transmission data rate (e.g., an average transmission data rate, a lowest transmission data rate, a highest transmission data rate, etc.) for each first group STA-AP channel and each second group STA-AP channel using the measured or obtained SNR values. The AP controller 106 may generate the combined transmission data rate based on each of the determined first group and second group transmission data rates (e.g., by averaging the first group and second group transmission data rates, by identifying a median transmission data rate in the first and second groups, etc.).

Once the AP controller 106 has identified the level of interference between different pairs of the first group of STAs 110A-D and a remaining unpaired group of STAs 110A-D in the input set, the AP controller 106 can identify a second group of STAs 110A-D in the input set that results in a lowest level of interference (e.g., a highest combined transmission data rate) out of all of the remaining unpaired groups of STAs 110A-D in the input set when paired with the first group of STAs 110A-D in the input set. The AP controller 106 can then pair the first group of STAs 110A-D with this second group of STAs 110A-D that results in the lowest level of interference. The pairing of two groups of STAs 110A-D may be referred to herein as “paired groups of STAs 110A-D.” The AP controller 106 can then, for the next remaining unpaired group of STAs 110A-D in the input set, repeat the above operations to identify another remaining unpaired group of STAs 110A-D in the input set that results in a lowest level of interference when paired with the next remaining unpaired group of STAs 110A-D in the input set and pair these two remaining unpaired group of STAs 110A-D. The AP controller 106 can then repeat these operations until each group of STAs 110A-D in the input set is paired with another group of STAs 110A-D in the input set. The multiple paired groups of STAs 110A-D may collectively be referred to as a set of paired groups of STAs 110A-D. The operations performed by the AP controller 106 to form the set of paired groups of STAs 110A-D (e.g., the operations that encompass starting with one group of STAs 110A-D in the input set and identifying the level of interference when paired with other groups to forming the set of paired groups of STAs 110A-D) may collectively be referred to herein as a group pairing process.

When the AP controller 106 formed the set of paired groups of STAs 110A-D, the AP controller 106 started with a first group of STAs 110A-D in the input set and then continued to remaining unpaired groups of STAs 110A-D in the input set. Starting with the first group of STAs 110A-D, however, may influence the pairs that are eventually formed to create the set of paired groups of STAs 110A-D. For example, it may be that a first group of STAs 110A-D in the input set results in a lowest level of interference if paired with a third group of STAs 110A-D in the input set, and that a second group of STAs 110A-D in the input set results in a lowest level of interference if paired with the third group of STAs 110A-D in the input set. Because the AP controller 106 started the group pairing process with the first group of STAs 110A-D in the input set, the AP controller 106 may pair the first and third groups of STAs 110A-D. The AP controller 106 may further pair the second group of STAs 110A-D with another group of STAs 110A-D that results in a level of interference that is low, but not as low as would occur if the second group of STAs 110A-D was paired with the third group of STAs 110A-D because the third group of STAs 110A-D has already been paired with the first group of STAs 110A-D. To account for this type of situation, the AP controller 106 can repeat the group pairing process a number of times that equals the number of groups of STAs 110A-D in the input set, where each group pairing process starts with a different group of STAs 110A-D in the input set. For example, the first group pairing process may start with the first group of STAs 110A-D in the input set, as explained above. The second group pairing process may start with the second group of STAs 110A-D in the input set, the third group pairing process may start with the third group of STAs 110A-D in the input set, and so on. As a result, the AP controller may form multiple sets of paired groups of STAs 110A-D, where the number of sets of paired groups of STAs matches the number of groups of STAs 110A-D in the input set.

The output set of groups of STAs 110A-D produced by the AP controller 106 at the conclusion of a grouping stage may be one of the sets of paired groups of STAs 110A-D. To determine which of the sets of paired groups of STAs 110A-D to select as the output set of groups of STAs 110A-D, the AP controller 106 can, for each set of paired groups of STAs 110A-D, identify the transmission data rate associated with each STA 110A-D in the respective set and the lowest transmission data rate of those identified transmission data rates. Thus, the AP controller 106 may identify the lowest STA transmission data rate for each set of paired groups of STAs. The AP controller 106 can then select as the output set of groups of STAs 110A-D the set of paired groups of STAs 110A-D that has the best (e.g., highest) lowest STA transmission data rate. If this grouping stage is the last grouping stage to be performed by the AP controller 106, then the output set of groups of STAs 110A-D may be the final grouping or partition of STAs 110A-D that are used when assigning time slices. For example, each STA group in the output set of groups of STAs 110A-D may correspond with a different partition, and the STAs 110A-D that fall within the same partition may be served in the same SP as described below.

At block 504, within each schedule period, time slices are assigned to each AP-STA pair included in the respective schedule period. For example, to perform the time slice assignment, the AP controller 106 may follow a set of network constraints. For example, the AP controller 106 may assign each STA 110A-D that corresponds with a particular partition to the same SP such that these STAs 110A-D are served in the same SP. An SP may include one or more time slices. The smallest time slice in an SP may be referred to herein as a base slice. The AP controller 106 may set the time duration of a base slice to be equal to a time duration of the SP divided by the number of STAs in a partition. The AP controller 106 may assign each serving AP 108A-I to at most a single assigned slice in an SP, where an assigned slice may be a contiguous time resource within an SP that can have a time duration that is a multiple of a time duration of a base slice. Generally, the time duration of a base slice may be sufficient for a single STA 110A-D to be served, and therefore the time duration of an assigned slice may be at least N times the time duration of a base slice, where N is the number of STAs 110A-D in the partition that a single AP 108A-I serves. In other words, the minimum slice size or slice time duration that the AP controller 106 may allocate to a serving AP 108A-I may be a time duration of the base slice multiplied by the number of STAs 110A-D in the partition that the serving AP 108A-I serves. An assigned slice may have a time duration that is longer than the minimum slice size because the AP controller 106 may assign multiple APs 108A-I to the same assigned slice (where the time duration of the assigned slice would then be at least the sum of the minimum slice time duration of each assigned AP 108A-I). In some embodiments, the AP controller 106 may allocate longer time slices near the beginning of the SP. In other embodiments, the AP controller 106 may allocate longer time slices near the end of the SP. In addition, if multiple STAs 110A-D are served by the same AP 108A-I, then the AP controller 106 may assign those STAs 110A-D to the same assigned slice.

Even with the network constraints, there may be multiple possible combinations of AP 108A-I and/or STA 110A-D time slice assignments within an SP. As an illustrative example, if 3 STAs are included in the same partition (e.g., STAs 110A, 110B, and 110C), then possible combinations of STA time slice assignments within the SP can include all 3 STAs 110A-C being assigned to the same time slice (and therefore the SP would include one time slice), 3 different combinations of two STAs 110A-C being assigned to the same time slice and the third STA 110A-C being assigned to a separate time slice (e.g., 110A and 110B in a first time slice and 110C in a second time slice, 110A and 110C in a first time slice and 110B in a second time slice, and 110B and 110C in a first time slice and 110A in a second time slice, where the SP would then include 2 time slices), and all 3 STAs 110A-C being assigned to a different time slice (and therefore the SP would include 3 time slices). The AP controller 106 may therefore implement a slicing combination algorithm that can be used to maximize a minimum achieve transmission data rate.

For example, the AP controller 106 can identify each possible slicing combination (e.g., each possible assignment of STAs 110A-D in the partition to a time slice) that satisfies some or all of the network constraints identified herein. For each possible slicing combination, the AP controller 106 can collect SINR and/or MCSs with which each STA 110A-D can be served for the respective slicing combination, determine an achievable transmission data rate of each STA 110A-D (e.g., which may be based on the MCSs, SNR, SINR, etc.), and determine the lowest achievable transmission data rate of the determined achievable transmission data rates. Thus, the AP controller 106 can identify the lowest achievable transmission data rate of each possible slicing combination. The AP controller 106 can then determine the best (e.g., highest) lowest achievable transmission data rate of all the possible slicing combinations and select the slicing combination that resulted in the best lowest achievable transmission data rate. The AP controller 106 may then assign STAs 110A-D and/or APs 108A-I to time slices in the SP in accordance with the selected slicing combination.

If multiple possible slicing combinations achieve the same best lowest achievable transmission data rate (e.g., two or more slicing combinations each have the highest lowest achievable transmission data rate), then the AP controller 106 may implement a tiebreaker to select the best slicing combination from these multiple slicing combinations. For example, the AP controller 106 may select the slicing combination that has the highest sum of STA transmission data rates, the highest average STA transmission data rate, the highest median STA transmission data rate, the best (e.g., highest) highest STA transmission data rate, and/or the like.

The AP controller 106 can repeat the above operations for each SP such that some or all of the STAs 110A-D in the multipoint environment are each assigned to a time slice in one of a plurality of SPs.

After the time slices are assigned, the routine 500 ends. While blocks 502 and 504 are described as being performed when executing routine 500, this is not meant to be limiting. For example, the AP controller 106 can independently assign time slices to AP-STA pairs, even if block 502 is not performed to partition the APs 108A-I and/or STAs 110A-D. In such a situation, some or all of the STAs 110A-D in the multipoint environment 100 may be eligible to be assigned a time slice in the same SP.

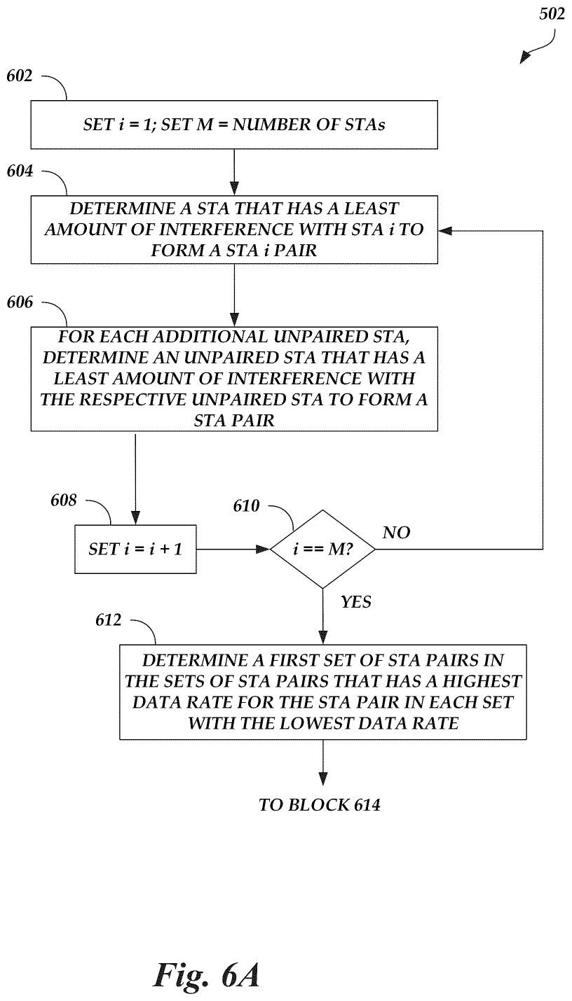

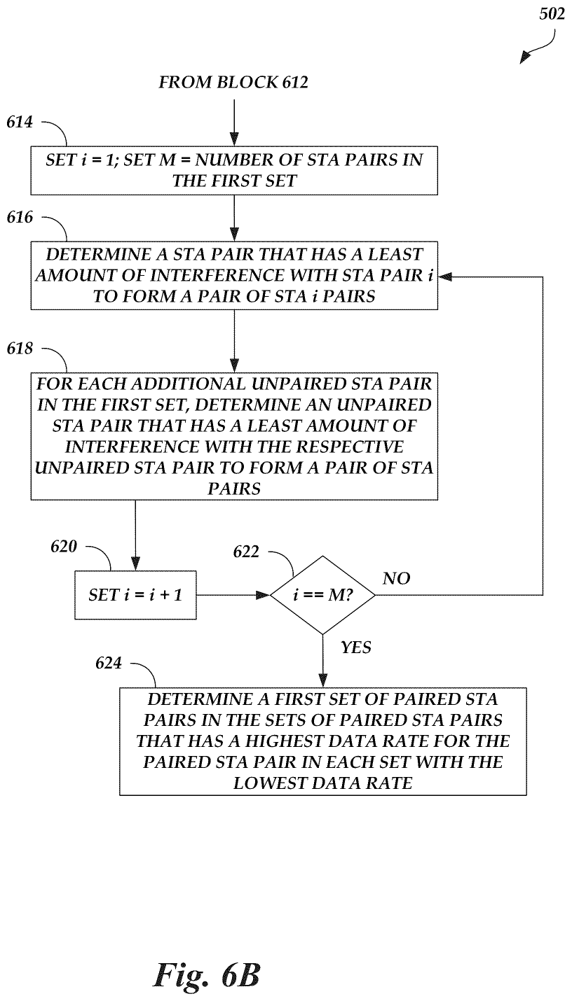

FIGS. 6A-6B depict flow diagrams depicting in greater detail a routine for partitioning each AP-STA pair across one or more SPs, according to one embodiment. As an example, the AP controller 106 can be configured to execute the routine, which may represent the operations performed in block 502 of FIG. 5 in a situation in which two grouping stages are to be performed. The routine of block 502 begins at block 602, as illustrated in FIG. 6A.

At block 602, a variable i is set to 1 and a variable M is set to be equal to the number of STAs 110A-D in the multipoint environment 100. The variable i may identify a particular STA 110A-D.

At block 604, a STA 110A-D that has a least amount of interference with STA i is determined to form a STA i pair.

At block 606, for each additional unpaired STA 110A-D, an unpaired STA 110A-D is determined that has a least amount of interference with the respective unpaired STA 110A-D to form a STA 110A-D pair. This may collectively result in the formation of a set of STA 110A-D pairs. In some cases, the total number of STAs 110A-D may be an odd number. Thus, one STA 110A-D may remain unpaired.

At block 608, the variable i is incremented by one.

At block 610, a determination is made to as whether i equals M. If i equals M, then the routine of block 502 proceeds to block 612. Otherwise, if i does not equal M, then the routine of block 502 reverts to block 604 and the routine continues to form additional sets of STA 110A-D pairs.

At block 612, a first set of STA 110A-D pairs in the sets of STA 110A-D pairs that has a highest data rate for the STA 110A-D pair in each set with the lowest data rate is determined. After determining the highest data rate for the STA 110A-D pair in each set with the lowest data rate, the routine of block 502 proceeds to block 614, as illustrated in FIG. 6B.

At block 614, a variable i is set to 1 and a variable M is set to be equal to the number of STA 110A-D pairs in the first set (e.g., the set with the highest lowest transmission data rate). The variable i may identify a particular STA 110A-D pair.

At block 616, a STA 110A-D pair that has a least amount of interference with STA pair i is determined to form a pair of STA i pairs (also referred to herein as “paired STA i pairs”).

At block 618, for each additional unpaired STA 110A-D pair in the first set, determine an unpaired STA 110A-D pair that has a least amount of interference with the respective unpaired STA 110A-D pair to form a pair of STA 110A-D pairs. This may collectively result in the formation of a set of pairs of STA 110A-D pairs (e.g., a set of paired STA 110A-D pairs).

At block 620, the variable i is incremented by one.

At block 622, a determination is made to as whether i equals M. If i equals M, then the routine of block 502 proceeds to block 624. Otherwise, if i does not equal M, then the routine of block 502 reverts to block 616 and the routine continues to form additional sets of pairs of STA 110A-D pairs (e.g., additional sets of paired STA 110A-D pairs).

At block 624, a first set of paired STA 110A-D pairs in the sets of paired STA 110A-D pairs that has a highest data rate for the paired STA 110A-D pair in each set with the lowest data rate is determined. After determining the highest data rate for the paired STA 110A-D pair in each set with the lowest data rate, the routine of block 502 ends.

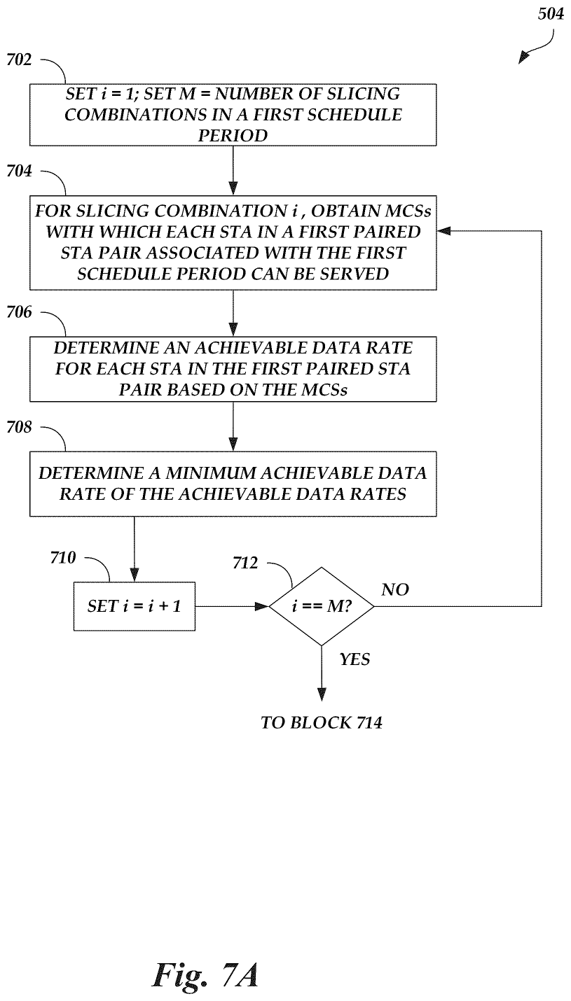

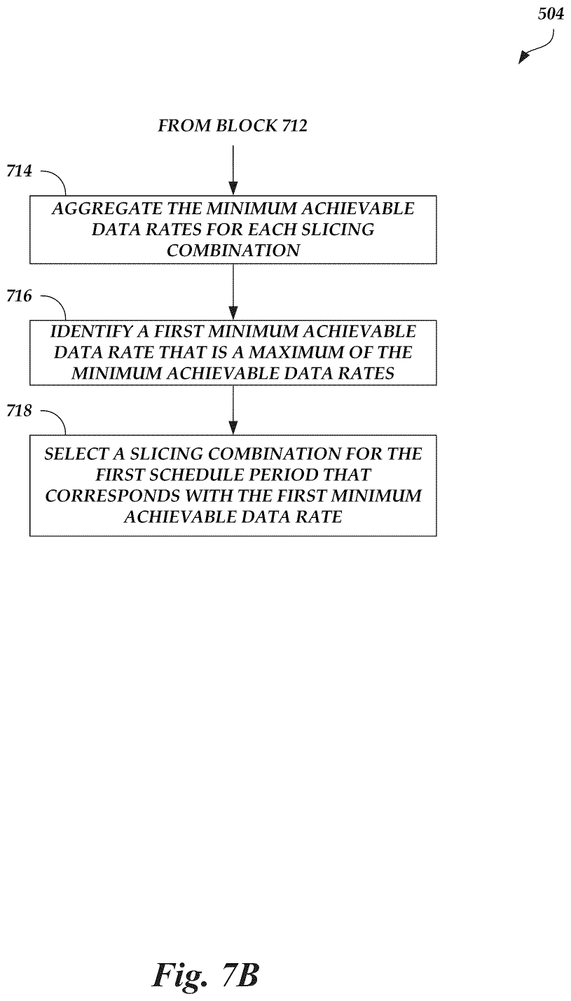

FIGS. 7A-7B depict flow diagrams depicting in greater detail a routine for assigning time slices, according to one embodiment. As an example, the AP controller 106 can be configured to execute the routine, which may represent the operations performed in block 504 of FIG. 5 in a situation in which two grouping stages are performed during the partitioning. The routine of block 504 begins at block 702, as illustrated in FIG. 7A.

At block 702, a variable i is set to 1 and a variable M is set to be equal to the number of possible slicing combinations in a first schedule period. The variable i may identify a particular slicing combination.

At block 704, for slicing combination i, MCSs with which each STA 110A-D in a first paired STA 110A-D pair associated with the first schedule period can be served is obtained. Optionally, SINRs with which each STA 110A-D in a first paired STA 110A-D pair associated with the first schedule period can be served are obtained, and the MCSs are derived from the SINRs. Alternatively, SINRs with which each STA 110A-D in a first paired STA 110A-D pair associated with the first schedule period can be served are obtained without subsequently deriving the MCSs.

At block 706, an achievable data rate is determined for each STA 110A-D in the first paired STA 110A-D pair based on the MCSs. Alternatively, an achievable data rate is determined for each STA 110A-D in the first paired STA 110A-D pair based on the SINRs.

At block 708, a minimum achievable data rate of the achievable data rates is determined.

At block 710, the variable i is incremented by one.

At block 712, a determination is made to as whether i equals M. If i equals M, then the routine of block 504 proceeds to block 714, as illustrated in FIG. 7B. Otherwise, if i does not equal M, then the routine of block 504 reverts to block 704 and the routine continues to determine a minimum achievable data rate for other slicing combinations.

At block 714, the minimum achievable data rates for each slicing combination are aggregated.

At block 716, a first minimum achievable data rate that is a maximum of the minimum achievable data rates is identified.

At block 718, a slicing combination for the first schedule period is selected that corresponds with the first minimum achievable data rate. In other words, the slicing combination with the best worst achievable data rate is selected. After the slicing combination is selected, the routine of block 504 ends.

### Association and Resource Allocation Routine

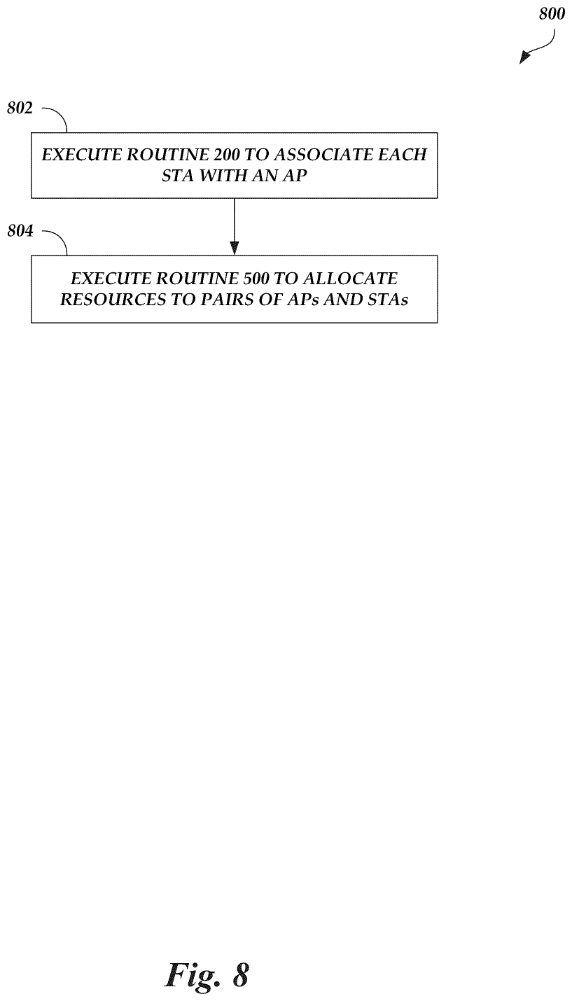

FIG. 8 is a flow diagram depicting an association and resource allocation routine 800 illustratively implemented by an AP controller, according to one embodiment. As an example, the AP controller 106 can be configured to execute the association and resource allocation routine 800. The association and resource allocation routine 800 begins at block 802.

At block 802, routine 200 is executed to associate each STA 110A-D with an AP 108A-I.

At block 804, routine 500 is executed to allocate resources to pairs of APs 108A-I and STAs 110A-D.

As described herein, the AP controller 106 can perform block 802 independent of performing block 804, and can perform block 804 independent of performing block 802. For example, the AP controller 106 can implement another approach for associating STAs 110A-D with APs 108A-I, and then perform block 804. Conversely, the AP controller 106 can perform block 802 and then implement another approach for allocating resources to the pairs of APs 108A-I and STAs 110A-D.

### Example Baseband Unit and Remote Radio Unit

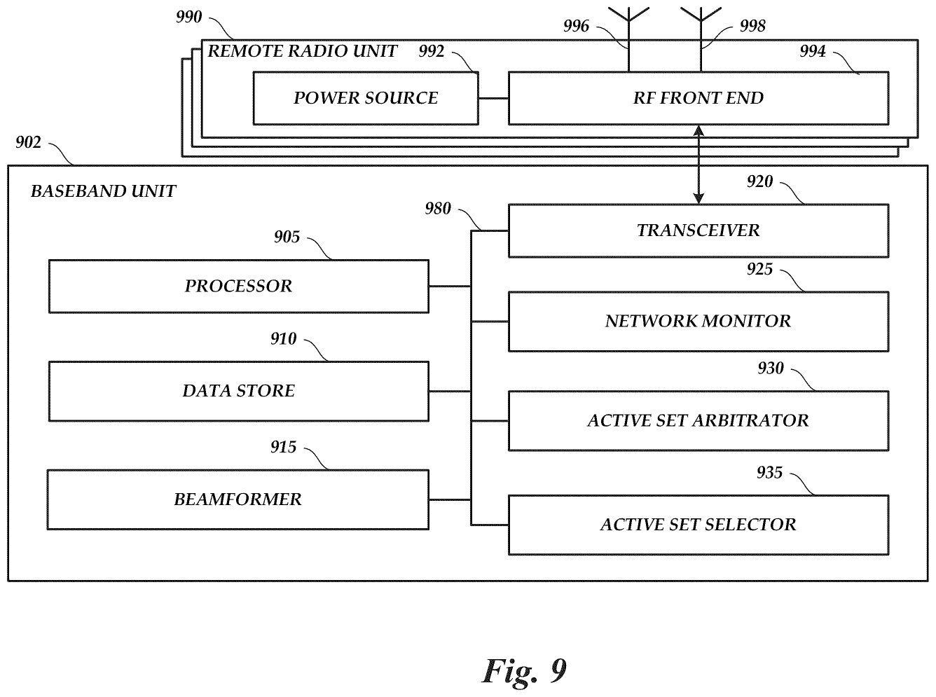

FIG. 9 is a block diagram illustrating an example baseband unit 902 and remote radio unit 990 according to an embodiment. The baseband unit 902 may be coupled with at least one remote radio unit 990. The remote radio unit 990 may include at least a first antenna 996 and a second antenna 998 for MIMO wireless communications. Any antenna disclosed herein, such as the antenna 996 or the antenna 998, can be referred to as antenna element. The first antenna 996 and the second antenna 998 may be coupled with a RF front end 994. The RF front end 994 may process signals received via the first antenna 996 and the second antenna 998. Part of processing a signal may include transmitting the signal to a transceiver 920 included in the BBU 902.

A processor 905 may receive signals received by the transceiver 920. The processor 905 may be configured to determine a type of the signal. For example, if the signal includes a request for connection services, the processor 905 may provide the signal to an active set selector 935. The active set selector 935 may be configured to identify an active set of serving nodes to provide the requested downlink data transmission service. The active set selector 935 can identify the active set for a STA based on information associated with the STA. Alternatively or additionally, the active set selector 935 can identify the active set for a STA based on information associated with one or more other STAs. In some instances, the active set selector 935 can identify specific spatial beam(s) selected to serve a STA. The BBU 902 may include a network monitor 925 to detect characteristics of the network such as the number of STAs served by each RRU, network data transmission load, and/or the like. The active set selector 935 may receive the network characteristics from the network monitor 925 as a factor considered when selecting spatial beam(s) to serve a STA and/or identifying an active set for a STA.

A beamformer 915 may be included in the BBU 902 to further identify parameters for the serving nodes (e.g., RRUs) included in an active set. The parameters may include one or more of transmission mode, time, frequency, power, beamforming matrix, tone allocation, or channel rank. The beamformer 915 may determine optimal parameters for RRUs coupled with the BBU 902 that facilitate a network-wide optimization of downlink data transmissions. In some implementations, the active set selector 935 determines an active set for a STA based, in part, on information provided by the STA. In other implementations, a UE may provide a requested active set. The BBU 902 may include an active set arbitrator 930 to reconcile a requested active set with an active set selected by the active set selector 935. The active set arbitrator 930 may compare a requested set of serving nodes to the serving nodes identified by the active set selector 935. The comparison may include ordering the serving nodes according to the STA recommendation. In some implementations, the active set arbitrator 930 may provide a message to the STA indicating confirmation or other assessment for a requested active set. For example, if the STA requested nodes A and B but the BBU 902 identified only B in the active set, the message may include a code indicating a partial match for the active set. Other status codes may be included to facilitate efficient communication and assessment of requested active sets. The active set arbitrator 930 may additionally or alternatively compare a requested transmission mode to the transmission mode identified by the active set selector 935 or other element of the BBU 902.

The BBU 902 may include a data store 910. The data store 910 may include instructions that can be executed by the processor 905 to implement the features described herein. In some implementations, the data store 910 may retain active sets or other scheduling information assigned to STAs served by the BBU 902 and/or channel state information. The data store 910 may be indexed by STA identifier and/or RRU identifier. This can expedite identification of previously communicated scheduling information for the STA and for monitoring network conditions (e.g., number of STAs allocated to an RRU or antenna element of an RRU).

Several elements included in the BBU 902 may be coupled by a bus 980. The bus 980 can be a data bus, communication bus, other bus, or any suitable combination thereof to enable the various components of the BBU 902 to exchange information.

In addition to providing the scheduling information to the STA, the scheduling information may be used to configure the RRU 990. The configuration may include adjusting the first antenna 996 such as by frequency modulation, time modulation, altering transmission power from a power source 992, or adjusting direction, tone allocation, or beamforming of the transmission.

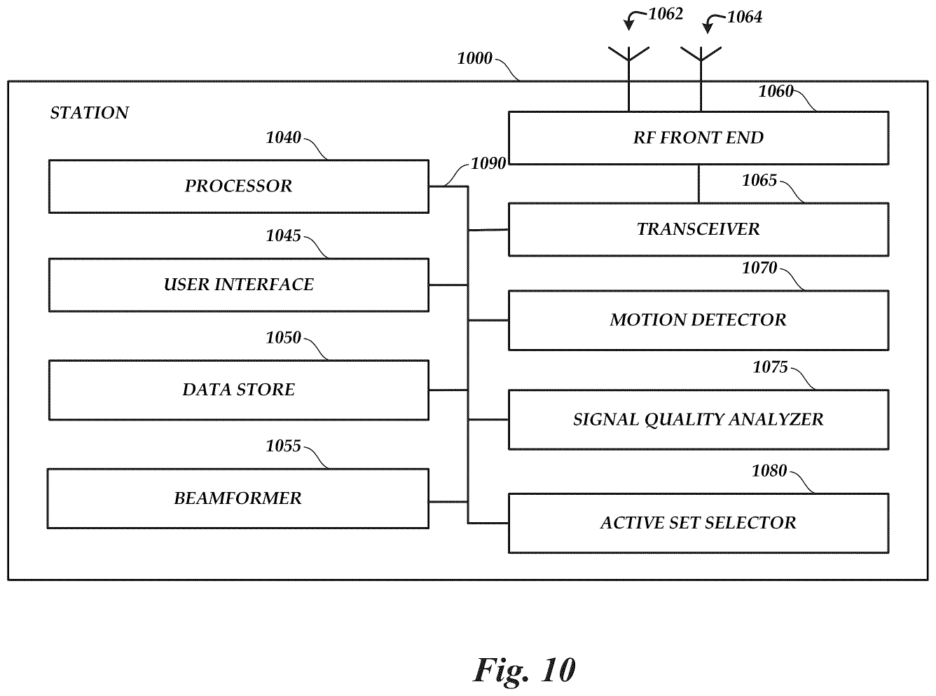

As discussed above, a variety of different STAs can wirelessly communicate with serving nodes in a cooperative MIMO network. An example STA will be discussed with reference to FIG. 10.

### Example STA

FIG. 10 is a schematic block diagram of an example STA 1000 according to an embodiment. The STA 1000 is configured for wirelessly communicating with a base station in a cooperative MIMO network. As illustrated in FIG. 10, the STA 1000 includes a processor 1040, a user interface 1045, a data store 1050, a beamformer 1055, antennas 1062 and 1064, a transceiver 1065, a motion detector 1070, a signal quality analyzer 1075, and an active set selector 1080. Some other STAs can include additional elements and/or a subset of the elements illustrated in FIG. 10.

The STA 1000 includes a plurality of antennas 1062 and 1064. Any suitable number of antennas can be included for wireless communication. The STA 1000 can include one or more arrays of antennas. A radio frequency (RF) front end 1060 can process RF signals received via the antennas 1062 and 1064. The RF front end can also provide RF signals to the antennas 1062 and 1064 for transmission. The transceiver 1065 includes a transmitter and a receiver. The transceiver 1065 can provide processing for transmitting and receiving RF signals associated with the antennas 1062 and 1064. For example, upon receiving active set data, the processor 1040 can configure the transceiver 1065 (e.g., receiver) to receive DL data associated with the spatial beam(s) identified in the active set data as being selected to serve the STA 1000.

The processor 1040 is in communication with the transceiver 1065. The processor 1040 is implemented by physical hardware arranged to perform specific operations to implement functionality related to determining a link strength of spatial beams over which beam pilots and/or user data are transmitted. The processor 1040 can determine the link strength, identify a spatial beam that provides the best link strength, and/or generate one or more messages to report the link strength to a serving node in accordance with any suitable principles and advantages disclosed herein. The processor 1040 can cause active set and neighbor set data to be stored and updated. The processor 1040 can perform any other suitable processing for the STA 1000.

The processor 1040 can be in communication with the motion detector 1070 and the signal quality analyzer 1075. Accordingly, the processor 1040 can receive and process information associated with conditions of the STA 1000. The motion detector 1070 can include any suitable hardware arranged to detect mobility information associated with the STA 1000. The signal quality analyzer 1075 can analyze the quality of signals received and/or transmitted by the antennas 1062 and 1064. This can provide information associated with a spatial channel condition of the STA 1000. The information associated with conditions of the STA 1000 can be provided to the processor 1040 for providing to the serving node(s). In some instances, some or all of the functionality of the motion detector 1070 and/or the signal quality analyzer can be implemented by the processor 1040.

The active set selector 1080 is optional and can identify a desired active set of one or more serving nodes. The active set selector 1080 can select the desired active set based on data associated with one or more of: one or more serving nodes in the active set, one or more serving nodes in the neighbor set, mobility data associated with the UE 1000, a spatial channel condition associated with the STA 1000, the link strength and/or the link quality of one or more spatial beams served by one or more serving nodes, or one or more characteristics of the STA 1000. The active set selector 1080 can optionally execute the active set management scheme to identify a desired active set. The active set selector 1080 can cause the processor 1040 to generate a message for transmission to a serving node and/or a BBU to request that a selected spatial beam (or selected spatial beams) be added to an active set for the STA 1000 (e.g., request that a selected spatial beam, which may be different than the spatial beam(s) already included in an active set for the STA 1000, be included in an updated active set for the STA 1000). The active set selector 1080 can be implemented by dedicated circuitry and/or circuitry of the processor 1040.

The beamformer 1055 can perform any suitable beamforming functionality for the STA 1000. The beamformer 1055 can set and/or adjust one or more parameters associated with receiving and/or transmitting signals associated with the antennas 1062 and 1064 of the STA 1000. The beamformer 1055 can be implemented by dedicated circuitry and/or circuitry of the processor 1040.

The STA 1040 includes a data store 1050. The data store 1050 can store instructions that can be executed by the processor 1040 to implement the features described herein. The data store 1050 can store active set data and neighbor set data for the STA 1000. The data store 1050 can store spatial beam link strengths and/or link qualities. The data store 1050 can store any other suitable data for the STA 1000. The data store 1050 can include any suitable memory elements arranged to store data.

Several elements included in the STA 1000 may be coupled by a bus 1090. The bus 1090 can be a data bus, communication bus, other bus, or any suitable combination thereof to enable the various components of the STA 1000 to exchange information.

As illustrated in FIG. 10, the STA 1000 also includes a user interface 1045. The user interface 1045 can be any suitable user interface, such as a display and/or an audio component. In some instances, the user interface 1045 can include one or more of touch screen capabilities, a button, a knob, a switch, or a slider.

### Terminology, Applications, and Conclusion

Depending on the embodiment, certain acts, events, or functions of any of the processes or algorithms described herein can be performed in a different sequence, can be added, merged, or left out altogether (e.g., not all described operations or events are necessary for the practice of the algorithm). Moreover, in certain embodiments, operations, or events can be performed concurrently, e.g., through multi-threaded processing, interrupt processing, or multiple processors or processor cores or on other parallel architectures, rather than sequentially.

Conditional language used herein, such as, among others, “can,” “could,” “might,” “may,” “e.g.,” and the like, unless specifically stated otherwise, or otherwise understood within the context as used, is generally intended to convey that certain embodiments include, while other embodiments do not include, certain features, elements, and/or steps. Thus, such conditional language is not generally intended to imply that features, elements, and/or steps are in any way required for one or more embodiments or that one or more embodiments necessarily include logic for deciding, with or without other input or prompting, whether these features, elements, and/or steps are included or are to be performed in any particular embodiment. The terms “comprising,” “including,” “having,” and the like are synonymous and are used inclusively, in an open-ended fashion, and do not exclude additional elements, features, acts, operations, and so forth. Additionally, the words “herein,” “above,” “below,” and words of similar import, when used in this application, shall refer to this application as a whole and not to any particular portions of this application. Where the context permits, words in the above Detailed Description of Certain Embodiments using the singular or plural may also include the plural or singular, respectively. Also, the term “or” is used in its inclusive sense (and not in its exclusive sense) so that when used, for example, to connect a list of elements, the term “or” means one, some, or all of the elements in the list.

Disjunctive language such as the phrase “at least one of X, Y, Z,” unless specifically stated otherwise, is otherwise understood with the context as used in general to present that an item, term, etc., may be either X, Y, or Z, or any combination thereof (e.g., X, Y, and/or Z). Thus, such disjunctive language is not generally intended to, and should not, imply that certain embodiments require at least one of X, at least one of Y, or at least one of Z to each be present.

Unless otherwise explicitly stated, articles such as “a” or “an” should generally be interpreted to include one or more described items. Accordingly, phrases such as “a device configured to” are intended to include one or more recited devices. Such one or more recited devices can also be collectively configured to carry out the stated recitations. For example, “a processor configured to carry out recitations A, B and C” can include a first processor configured to carry out recitation A working in conjunction with a second processor configured to carry out recitations B and C.

The word “coupled,” as generally used herein, refers to two or more elements that may be either directly coupled to each other, or coupled by way of one or more intermediate elements. Likewise, the word “connected,” as generally used herein, refers to two or more elements that may be either directly connected, or connected by way of one or more intermediate elements.

As used herein, the terms “determine” or “determining” encompass a wide variety of actions. For example, “determining” may include calculating, computing, processing, deriving, generating, obtaining, looking up (e.g., looking up in a table, a database or another data structure), ascertaining and the like via a hardware element without user intervention. Also, “determining” may include receiving (e.g., receiving information), accessing (e.g., accessing data in a memory) and the like via a hardware element without user intervention. Also, “determining” may include resolving, selecting, choosing, establishing, and the like via a hardware element without user intervention.

As used herein, the terms “provide” or “providing” encompass a wide variety of actions. For example, “providing” may include storing a value in a location of a storage device for subsequent retrieval, transmitting a value directly to the recipient via at least one wired or wireless communication medium, transmitting or storing a reference to a value, and the like. “Providing” may also include encoding, decoding, encrypting, decrypting, validating, verifying, and the like via a hardware element.

As used herein, the term “message” encompasses a wide variety of formats for communicating (e.g., transmitting or receiving) information. A message may include a machine readable aggregation of information such as an XML document, fixed field message, comma separated message, or the like. A message may, in some implementations, include a signal utilized to transmit one or more representations of the information. While recited in the singular, it will be understood that a message may be composed, transmitted, stored, received, etc. in multiple parts.

As used herein a “user interface” (also referred to as an interactive user interface, a graphical user interface or a UI) may refer to a network based interface including data fields and/or other controls for receiving input signals or providing electronic information and/or for providing information to the user in response to any received input signals. A UI may be implemented in whole or in part using technologies such as hyper-text mark-up language (HTML), Flash, Java, .net, web services, and rich site summary (RSS). In some implementations, a UI may be included in a stand-alone client (for example, thick client, fat client) configured to communicate (e.g., send or receive data) in accordance with one or more of the aspects described.

As used herein a “transmit-receive point” (TRP) (which can alternatively be referred to as a transmission reception point) may refer to a transceiver device or one transceiver element included in a device. When included as a transceiver element, the device may include multiple TRPs. The TRP may include one or more antennas which are coupled to signal processing circuitry. The signal processing circuitry may be included in the device. The TRP may include additional elements to facilitate transmission or receipt of wireless signals for one or more UEs. Example of such elements may include a power source, amplifier, digital-to-analog converter, analog-to-digital converter, or the like. When a TRP is allocated, such as by a BBU, to provide service to a UE, the TRP may be said to be a “serving node” for the UE.

As used herein a “remote radio unit” (RRU) may refer to a device for controlling and coordinating transmission and receipt of wireless signals for one or more UEs. An RRU may include or be coupled with one or more TRPs. The RRU may receive signals from the TRP and include the signal processing circuitry. The signal processing circuitry may be selectively operated to facilitate processing of signals associated with different TRPs.

While the above detailed description has shown, described, and pointed out novel features as applied to various embodiments, it can be understood that various omissions, substitutions, and changes in the form and details of the devices or algorithms illustrated can be made without departing from the spirit of the disclosure. For example, circuit blocks and/or method blocks described herein may be deleted, moved, added, subdivided, combined, arranged in a different order, and/or modified. Each of these blocks may be implemented in a variety of different ways. Any portion of any of the methods disclosed herein can be performed in association with specific instructions stored on a non-transitory computer readable storage medium being executed by one or more processors. As can be recognized, certain embodiments described herein can be embodied within a form that does not provide all of the features and benefits set forth herein, as some features can be used or practiced separately from others. The scope of certain embodiments disclosed herein is indicated by the appended claims rather than by the foregoing description. All changes which come within the meaning and range of equivalency of the claims are to be embraced within their scope.

What is claimed is:

1. An access point controller comprising:
a network interface; and
a processor in communication with the network interface, wherein computer-executable instructions, when executed by the processor, cause the access point controller to:
identify a plurality of slicing combinations for assigning a time slice in a schedule period to a station (STA) in a plurality of STAs in a multipoint environment;
for each slicing combination in the plurality of slicing combinations, determine an achievable transmission data rate for each STA in the plurality of STAs if assigned to a time slice in accordance with the respective slicing combination;
for each slicing combination in the plurality of slicing combinations, determine a minimum achievable transmission data rate of the determined achievable transmission data rates for the respective slicing combination;
aggregate the minimum achievable transmission data rates;
identify a first minimum achievable transmission data rate that is a maximum of the minimum achievable transmission data rates; and
select a first slicing combination in the plurality of slicing combinations that corresponds with the first minimum achievable transmission data rate.

2. The access point controller of claim 1, wherein the computer-executable instructions, when executed, further cause the access point controller to partition a second plurality of STAs into the plurality of STAs and a third plurality of STAs, wherein the plurality of STAs is associated with the schedule period, and wherein the third plurality of STAs is associated with a second schedule period.

3. The access point controller of claim 2, wherein the computer-executable instructions, when executed, further cause the access point controller to:
pair a first STA and a second STA in the second plurality of STAs to form a first STA pair based on a first level of interference associated with pairing the first STA and the second STA;
pair a third STA and a fourth STA in the second plurality of STAs to form a second STA pair based on a second level of interference associated with pairing the third STA and the fourth STA, wherein the first STA pair and the second STA pair form a first set;
pair the second STA and the third STA to form a third STA pair based on a third level of interference associated with pairing the second STA and the third STA;
pair the fourth STA and the first STA to form a fourth STA pair based on a fourth level of interference associated with pairing the fourth STA and the first STA, wherein the third STA pair and the fourth STA pair form a second set;
determine that a first transmission data rate associated with the first STA pair is lower than a second transmission data rate associated with the second STA pair;
determine that a third transmission data rate associated with the third STA pair is lower than a fourth transmission data rate associated with the fourth STA pair;
determine that the first transmission data rate is greater than the third transmission data rate; and
form the plurality of STAs based on the first STA pair and the third plurality of STAs based on the second STA pair.

4. The access point controller of claim 1, wherein the computer-executable instructions, when executed, further cause the access point controller to associate each STA in the plurality of STAs with an access point in a plurality of access points.

5. The access point controller of claim 4, wherein the computer-executable instructions, when executed, further cause the access point controller to:
determine a set of potential resident STAs in the plurality of STAs for each access point in the plurality of access points based on a metric;
determine a set of viable primary access points in the plurality of access points for each STA in the plurality of STAs;
assign an access point in the plurality of access points to each unassociated STA in the plurality of STAs; and
update a current resident STA of each access point in the plurality of access points based on the metric and a maximum number of potential resident STAs that the respective access point can serve.

6. The access point controller of claim 5, wherein the computer-executable instructions, when executed, further cause the access point controller to assign a first unassociated STA in the plurality of STAs to a first access point in the plurality of access points that has a highest signal to noise ratio (SNR) with the first unassociated STA of the access points in the plurality of access points that are not serving a maximum number of STAs in the plurality of STAs.

7. The access point controller of claim 5, wherein the metric comprises a signal to noise ratio (SNR) measurement.

8. The access point controller of claim 5, wherein each unassociated STA in the plurality of STAs comprises a STA in the plurality of STAs that is not assigned to an access point in the plurality of access points.

9. The access point controller of claim 1, wherein the computer-executable instructions, when executed, further cause the access point controller to:
identify a second minimum achievable transmission data rate that is the maximum of the minimum achievable transmission data rates, wherein the second minimum achievable transmission data rate corresponds with a second slicing combination in the plurality of slicing combinations; and
select the first slicing combination in response to a determination that the first slicing combination has a tiebreaker over the second slicing combination.

10. The access point controller of claim 9, wherein the tiebreaker is based on the first slicing combination having one of a higher sum of achievable transmission data rates for the plurality of STAs, a higher average achievable transmission data rate for the plurality of STAs, a higher median achievable transmission data rate for the plurality of STAs, or a higher maximum achievable transmission data rate for the plurality of STAs than the second slicing combination.

11. A computer-implemented method comprising:
identifying a plurality of slicing combinations for assigning a time slice in a schedule period to a station (STA) in a plurality of STAs in a multipoint environment;
for each slicing combination in the plurality of slicing combinations, determining an achievable transmission data rate for each STA in the plurality of STAs if assigned to a time slice in accordance with the respective slicing combination;
for each slicing combination in the plurality of slicing combinations, determining a minimum achievable transmission data rate of the determined achievable transmission data rates for the respective slicing combination;
aggregating the minimum achievable transmission data rates;
identifying a first minimum achievable transmission data rate that is a maximum of the minimum achievable transmission data rates; and
selecting a first slicing combination in the plurality of slicing combinations that corresponds with the first minimum achievable transmission data rate.

12. The computer-implemented method of claim 11, further comprising partitioning a second plurality of STAs into the plurality of STAs and a third plurality of STAs, wherein the plurality of STAs is associated with the schedule period, and wherein the third plurality of STAs is associated with a second schedule period.

13. The computer-implemented method of claim 12, wherein partitioning a second plurality of STAs further comprises:
pairing a first STA and a second STA in the second plurality of STAs to form a first STA pair based on a first level of interference associated with pairing the first STA and the second STA;
pairing a third STA and a fourth STA in the second plurality of STAs to form a second STA pair based on a second level of interference associated with pairing the third STA and the fourth STA, wherein the first STA pair and the second STA pair form a first set;
pairing the second STA and the third STA to form a third STA pair based on a third level of interference associated with pairing the second STA and the third STA;
pairing the fourth STA and the first STA to form a fourth STA pair based on a fourth level of interference associated with pairing the fourth STA and the first STA, wherein the third STA pair and the fourth STA pair form a second set;
determining that a first transmission data rate associated with the first STA pair is lower than a second transmission data rate associated with the second STA pair;
determining that a third transmission data rate associated with the third STA pair is lower than a fourth transmission data rate associated with the fourth STA pair;
determining that the first transmission data rate is greater than the third transmission data rate; and
forming the plurality of STAs based on the first STA pair and the third plurality of STAs based on the second STA pair.

14. The computer-implemented method of claim 11, further comprising associating each STA in the plurality of STAs with an access point in a plurality of access points.

15. The computer-implemented method of claim 14, wherein associating each STA in the plurality of STAs with an access point in a plurality of access points further comprises:
determining a set of potential resident STAs in the plurality of STAs for each access point in the plurality of access points based on a metric;
determining a set of viable primary access points in the plurality of access points for each STA in the plurality of STAs;
assigning an access point in the plurality of access points to each unassociated STA in the plurality of STAs; and
updating a current resident STA of each access point in the plurality of access points based on the metric and a maximum number of potential resident STAs that the respective access point can serve.

16. The computer-implemented method of claim 15, wherein assigning an access point further comprises assigning a first unassociated STA in the plurality of STAs to a first access point in the plurality of access points that has a highest signal to noise ratio (SNR) with the first unassociated STA of the access points in the plurality of access points that are not serving a maximum number of STAs in the plurality of STAs.

17. The computer-implemented method of claim 15, wherein the metric comprises a signal to noise ratio (SNR) measurement.

18. The computer-implemented method of claim 15, wherein each unassociated STA in the plurality of STAs comprises a STA in the plurality of STAs that is not assigned to an access point in the plurality of access points.

19. The computer-implemented method of claim 11, wherein selecting the first slicing combination further comprises:
identifying a second minimum achievable transmission data rate that is the maximum of the minimum achievable transmission data rates, wherein the second minimum achievable transmission data rate corresponds with a second slicing combination in the plurality of slicing combinations; and
selecting the first slicing combination in response to a determination that the first slicing combination has a tiebreaker over the second slicing combination.

20. The computer-implemented method of claim 19, wherein the tiebreaker is based on the first slicing combination having one of a higher sum of achievable transmission data rates for the plurality of STAs, a higher average achievable transmission data rate for the plurality of STAs, a higher median achievable transmission data rate for the plurality of STAs, or a higher maximum achievable transmission data rate for the plurality of STAs than the second slicing combination.
